(19) United States
(12) Patent Application Publication
(10) Pub. No.: US 2013/0006682 A1
(43) Pub. Date: Jan. 3, 2013

(54) REAL-TIME QUANTITATIVE AND QUALITATIVE MEASUREMENT OF ORGANIZATIONAL CULTURE

(75) Inventors: George Huff, Portland, OR (US); Jeff Reynolds, Portland, OR (US); David Gorman, Portland, OR (US); Matthew Scott Barnett, Edmonton (CA); Jordan Cole, Portland, OR (US); Matt Oxley, London (GB); James Parr, London (GB)

(73) Assignee: Opal Labs Inc., Portland, OR (US)

(21) Appl. No.: 13/175,460

(22) Filed: Jul. 1, 2011

(51) Int. Cl. G06Q 10/00

(52) U.S. Cl. 705/7.11

(57) ABSTRACT

Disclosed are methods, systems, apparatuses, and non-transitory computer-readable media for facilitating measurement of organizational culture in real time. In embodiments, an organization culture measurement system may facilitate culture measurement through receipt and comparison of various actions performed by persons associated with the organization. The organization culture measurement system may provide a networking and interaction interface for users within an organization to interact with each other. User actions in the networking and interaction interface may be received by the organization culture measurement system and used to associate one or more cultural classifications and/or signifiers with users. Cultural classifications and/or signifiers associated with users may be used to measure organizational culture on a wider level and incentivize desired cultural traits. Aggregation of classification of users of the networking and interaction interface may allow the organization, as well as external stakeholders, to see high-level measurement of the culture of those using the interface.

### BACKGROUND

As organizations, such as businesses or non-profit groups, grow, change, and/or merge, they oftentimes find themselves attempting to assess their cultural qualities in order to better understand their strengths, weaknesses, and preparedness for dealing with changing external scenarios. However, measurement of cultural aspects can be difficult. Organizations may not have available to them tools and resources needed to gather information with which to make cultural measurements. In some situations, organizations rely on surveys, cultural audits, or other single-use techniques. However, these techniques take time and energy, and may not produce accurate, unbiased results. Additionally, such techniques may require the use of many organizational resources, providing operational disruption of the organization. Moreover, these techniques demonstrate only a thin slice of the moment in time of the audit or survey. Such frozen-in-time information illuminates little in the way of organizational trends or causes and effects. Additionally, some organizations may find that they are simply too large to consistently monitor their employees and associates to determine cultural differences. These organizations may also find that they are unable to measure culture at different levels of granularity and across different departments and geographical zones. Access to tools and techniques that facilitate cultural measurement may provide for organizations to better marshal their resources and improve their planning as they address the ongoing challenges of their business.

### BRIEF DESCRIPTION OF THE DRAWINGS

Embodiments of the present invention will be readily understood by the following detailed description in conjunction with the accompanying drawings and flow charts. Embodiments of the invention are illustrated by way of example and not by way of limitation in the figures of the accompanying drawings.

FIG. 1 is a block diagram illustrating interactions between users and a organization culture measurement system;

FIG. 2 is a block diagram illustrating components and interactions within the organization culture measurement system;

FIG. 3 is a flowchart illustrating an exemplary process for measuring organizational culture;

FIG. 4 is a flowchart illustrating an exemplary process for the organization culture measurement system to generate a networking and interaction interface;

FIGS. 5a and 5b are exemplary interfaces through which a super user may view and/or modify motivators;

FIG. 6 is a flowchart illustrating an exemplary process for the organization culture measurement system to receive cultural signifier definitions;

FIG. 7 is an exemplary interface for a super user to generate a cultural signifier;

FIG. 8 is another exemplary interface for a super user to generate a cultural signifier;

FIG. 9 is another exemplary interface for a super user to generate a cultural signifier;

FIG. 10 is an exemplary interface for a super user to view and manage generated cultural signifiers;

FIG. 11 is a flowchart illustrating an exemplary process for the organization culture measurement system to receive user actions;

FIG. 12 is a flowchart illustrating an exemplary process for the organization culture measurement system to update a cultural measure for an organization;

FIG. 13 is an exemplary interface through which a user may observe actions that have been captured by the organization culture measurement system;

FIG. 14 is another exemplary interface through which a user may observe actions that have been captured by the organization culture measurement system;

FIG. 15 is an exemplary interface provided by the organization culture measurement system for a user to observe degrees of cultural classifications pertaining to the user;

FIG. 16 is a flowchart illustrating an exemplary process for the organization culture measurement system to update user cultural classifications;

FIG. 17 is a an exemplary interface provided by the organization culture measurement system for a user to observe obtainable cultural signifiers;

FIGS. 18a and 18b are examples of interfaces for a user to view earned cultural signifiers;

FIG. 19 is a flowchart illustrating an exemplary process for the organization culture measurement system to update badge assignments for a user;

FIG. 20 is a flowchart illustrating an exemplary process for the organization culture measurement system to update organization culture measurement;

FIG. 21 is an exemplary interface for a super user to view aggegrated cultural measurements;

FIG. 22 is another exemplary interface for a super user to view aggegrated cultural measurements;

FIG. 23 is a flowchart illustrating an exemplary process for the organization culture measurement system to inform users of updates; and

FIG. 24 is a block diagram illustrating a generalized example of a computing environment on which several of the described embodiments may be implemented.

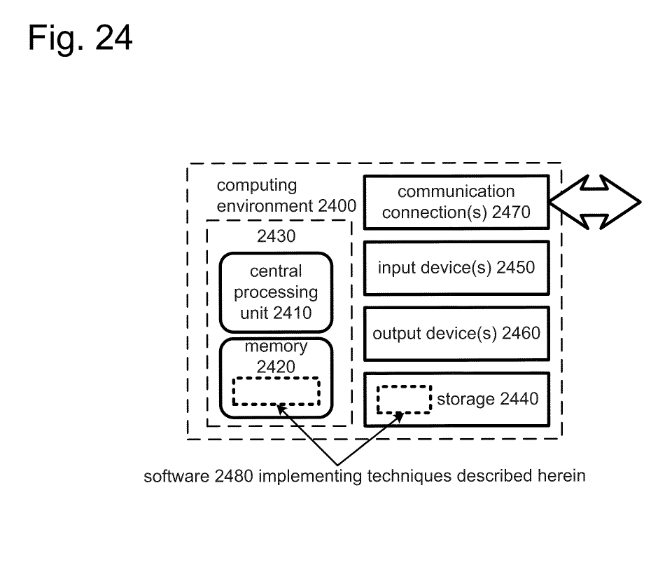

All figures are ranged in accordance with various embodiments of the present disclosure.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents.

Various operations may be described as multiple discrete operations in turn, in a manner that may be helpful in understanding embodiments of the present invention; however, the order of description should not be construed to imply that these operations are order dependent.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (A and B) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments or implementations of the present invention, are synonymous. The term “exemplary” is used herein merely illustrates that an example is being shown or described and is not intended to denote that any so-described feature is preferred or required over any other. Additionally, while flowcharts and descriptions of processes may make reference to particular steps, it should be understood that, in alternative implementations, the illustrated steps may be combined or divided into two or more sub-steps.

Various embodiments are directed to computer-implemented methods, processes, systems, apparatuses, and non-transitory computer-readable media for facilitating real-time measurement and shifting of organizational culture. In various embodiments, an organization culture measurement system may facilitate culture measurement through receipt and comparison of various actions performed by persons associated with the organization. In various embodiments, the organization culture measurement system may provide a networking and interaction interface for users within an organization (or otherwise associated with the organization) to interact with each other. In various embodiments, this networking and interaction interface may comprise a social network interface. In various embodiments, actions by users in the networking and interaction interface may be received by the organization culture measurement system and used to associate one or more cultural classifications and/or cultural signifiers with users. In various embodiments, actions may be summed or otherwise aggregated to assign cultural classifications and/or cultural signifiers on a real-time basis. In some embodiments, the organizational culture measurement system may utilize a rule-based architecture to assign cultural classifications and/or cultural signifiers.

In various embodiments, cultural classifications and/or cultural signifiers associated with users may be used to dynamically measure organizational culture on a wider level on a real-time basis. For example, the organization culture measurement system may facilitate dynamic, real-time mapping (or other reporting) of the types of persons associated with the organization based on their cultural classifications and/or cultural signifiers. This demonstration may, in various embodiments, be provided in a graphical interface form for review by one or more persons who make decisions for the organization. In various embodiments, aggregation of classification of users of the networking and interaction interface may allow the organization to see high-level measurement of the culture of those using the interface, and thus, the people who work in the organization. In various embodiments, this measurement may be taken at various levels, such as per-department, or per-site.

In various embodiments, in addition to providing measurement and reporting on organization culture, the organization culture measurement system may allow users to determine that an organization's culture needs to be shifted in a particular direction. In various embodiments, the organization culture measurement system may provide for users to modify the system in order to provide incentives for persons in the organization to modify their behavior. For example, a user may determine, through visualization and reporting techniques described herein, that it would be desirable to see more creative thinking in the organization. The user may then modify how cultural classifications and/or cultural signifiers are provided to persons in the organization in order to incentivize creative behavior. Additionally, the organization culture measurement system may facilitate a user in incentivizing actions through the use of an online marketplace that provides a point-based currency to purchase tangible and/or intangible products that are desirable to persons in the organization.

Embodiments described herein may be focused on operations and persons associated with an “organization”. In various embodiments, an “organization” may include various for-profit and non-profit associations, including corporations, incorporated companies, charities, performance or other arts groups, social groups, or other associations of persons. In some embodiments, an “organization” may consist of persons with some degree of physical proximity; in others, an organization may exist between people that interact entirely through online means. Additionally, while embodiments described herein make reference to “users” or “persons” associated with organizations, in various embodiments, these terms may refer to various individuals without specific requirements of how or in what capacity these users or persons are associated with one or more organizations. “Culture”, as used herein, may refer to, among other things, patterns of shared assumptions, styles of thinking, decision making, problem solving, modes of work, and interactions between persons involved the organization. In various embodiments, culture may further refer to such patterns that have shown value to the organization.

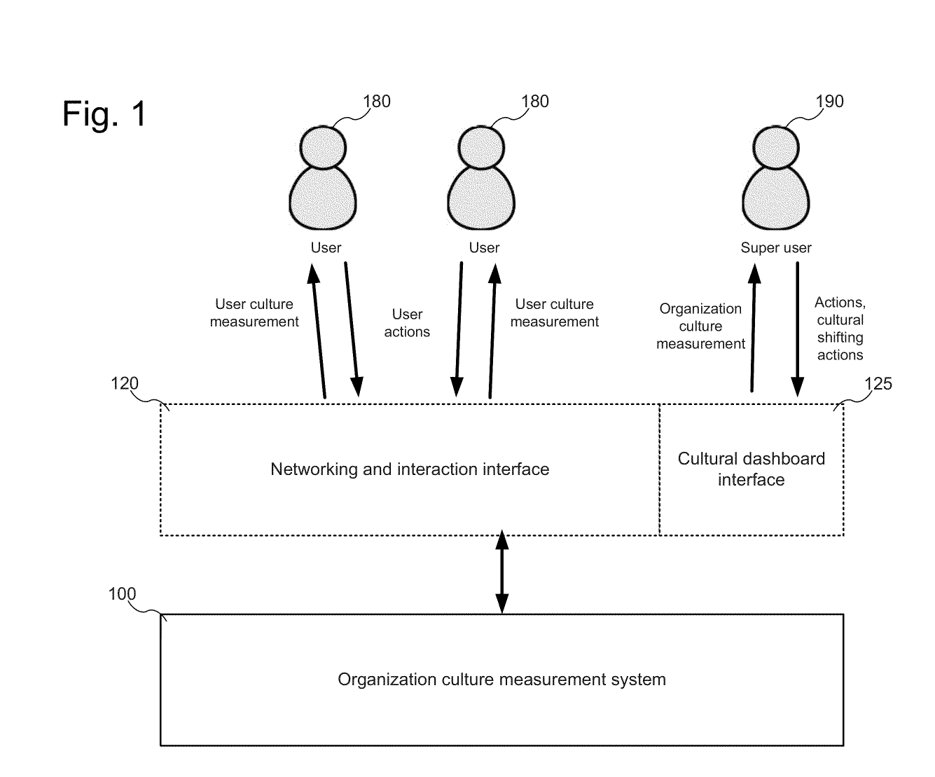

FIG. 1 is a block diagram illustrating interactions between user(s) 180 and an organization culture measurement system 100. As FIG. 1 illustrates, in various embodiments, the organization culture measurement system 100 may provide a networking and interaction interface 120 through which user(s) 180 in an organization may interact. In various embodiments, the networking and interaction interface 120 may comprise a networking and interaction interface. In various embodiments, the networking and interaction interface 120 may comprise a web-based interface, such as an interface served at the direction of the organization culture measurement system 100. Such a networking and interaction interface 120 may be accessed by user(s) 180 over a web browser or other networked application. In other embodiments, the networking and interaction interface 120 may comprise one or more applications which may operate natively on computing devices operated by the user(s) 180 or pushed to broadcast interfaces. In these embodiments, the networking and interaction interface 120 may interact with the organization culture measurement system 100 through the use of intermediate interfaces, such as, for example, application program interfaces.

User(s) 180 may perform one or more networking actions with the networking and interaction interface 120 that may be received by the organization culture measurement system 100. For example, in various embodiments, the user(s) 180 may post text, image, or video content or links to the networking and interaction interface 120 for viewing by others. In various embodiments, user(s) 180 may view posted materials, make comments on posted materials, and/or rate other users' content and/or comments through the networking and interaction interface 120. In various embodiments, user(s) 180 may create challenges for other users, such as to request that one or more user(s) 180 to which particular classifications have been assigned perform a task. The offering of challenges by users may allow other users to respond to needs or desires in the organization. In some embodiments, the organization culture measurement system 100 may also receive indications of actions and interactions performed by users(s) 180 outside of the networking and interaction interface 120 and may additionally use these to measure and report on organization culture.

In various embodiments, the user(s) 180 may receive user culture measurements from the organization culture measurement system 100 through the organization culture measurement system 100, such as through provision of a user cultural profile. Particular embodiments of these measurements are described herein, but may include classification of the user according to one or more cultural classifications and/or assignment of one or more cultural signifiers. In various embodiments, the cultural signifiers may take the form of one or more badges and/or rewards which are displayed for a user in the networking and interaction interface 120; in other embodiments, cultural signifiers may take other forms. In various embodiments, the cultural feedback provided by the organization culture measurement system 100 may provide a user 180 an indication of how he or she interacts with other users of the networking and interaction interface 120, and thus how he or she interacts within the organization. Additionally, the user(s) 180 may be motivated due to the feedback provided by the user culture measurement to modify or, alternatively, to continue particular habits and interactions. This may provide a feedback loop through which persons in the organization may improve their interactions in the organization, thereby improving the organization as a whole.

In various embodiments, the networking and interaction interface 120 may also interact with a super user 190. In various embodiments, the super user 190 may interact with the networking and interaction interface 120 as with the user(s) 180 described above. In various embodiments, the super user may also interact with a cultural dashboard interface 125 provided by the networking and interaction interface 120 as an interface to receive organization culture measurements. For example, the super user 190 may receive information about cultural classifications or signifiers to which various users have been assigned. In other embodiments, the cultural dashboard interface 125 may provide the super user 190 with aggregate cultural measurements for multiple users 180. Thus, the super user 190, using the cultural dashboard interface 125, may view cultural measurement of one or more subgroups, such as, for example, departments, interest groups, project-related groups, job sites, offices, age groups, other demographic groups, and/or of the organization as a whole. In various embodiments, the super user 190 may also issue one or more challenges to user(s) 180 through the networking and interaction interface 120, such as to request that one or more user(s) 180 to which particular classifications have been assigned perform a task. In some embodiments, the super user 190 may also challenge user(s) 180 to attain particular cultural signifiers, such as badges. In various embodiments, the super user 190 may also interact with the cultural dashboard 125 in order to provide incentives, challenges, and/or other incentives in order to affect or otherwise shift organizational culture. In some alternative embodiments, the culture measurement received by the user(s) 180 and/or the super user 190 may be obtained through an interface other than the cultural dashboard 125.

In various embodiments, super user(s) 190 may be employees or other persons associated with the organization; in other embodiments, super user(s) 190 may be persons outside of the organization, such as consultants or other persons tasked with operating or maintain the organization culture measurement system 100. In various embodiments, multiple organization culture measurement systems 100 may be interacted with by a given super user; in such embodiments, features of the networking and interaction interface 120 may allow the super user to define and view cultural measurement and to make adjustments for multiple organizations using multiple organization culture measurement systems 100.

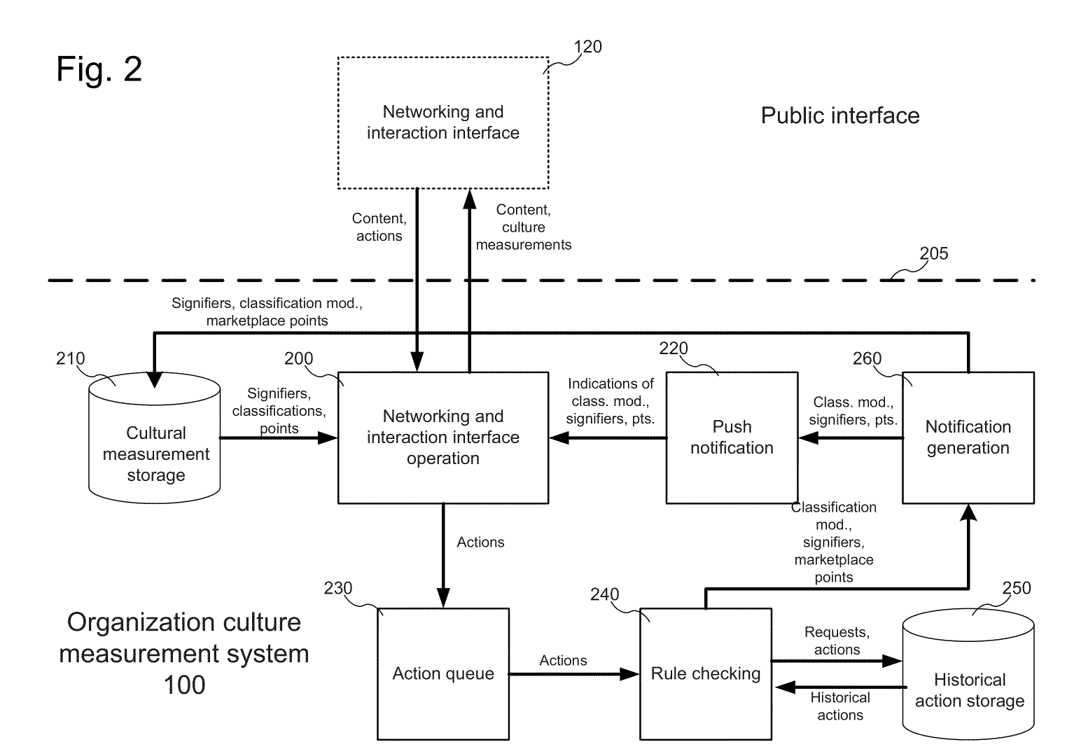

FIG. 2 is a block diagram illustrating components and interactions within the organization culture measurement system 100. While the example of FIG. 2 illustrates particular components and interactions, in various embodiments, the organization culture measurement system 100 may include additional components, and/or one or more illustrated components may be merged or omitted. As FIG. 2 illustrates, in various embodiments, the organization culture measurement system 100 may include a networking and interaction interface operation module 200, which may be configured to generate and interact with the networking and interaction interface 120. In various embodiments, the interface operation module 200 may further be configured to generate and interact with the cultural dashboard interface 125 as part of networking and interaction interface 120. As discussed above, in various embodiments, the networking and interaction interface operation module 200 may generate a web-based networking and interaction interface 120, or may provide the interface through interactions with one or more native client applications (not illustrated).

In various embodiments, the networking and interaction interface 120 may send indications of content, actions, and/or challenges received from users, such as user(s) 180, to the networking and interaction interface operation module 200. In turn, in various embodiments, the networking and interaction interface operation module 200 may send information to users through the networking and interaction interface 120, such as, for example, content and culture measurements, as described above. As discussed above, in some embodiments, the networking and interaction interface 120 may comprise a networking and interaction interface.

As mentioned herein, in various embodiments, the networking and interaction operation interface 200, may receive indications of actions performed by users in the networking and interaction interface 120. In the illustration of FIG. 2 these action indications are illustrated simply as “actions” for the sake of simple illustration; no particular limitation on the communication of action indications should be assumed based on the illustration. In various embodiments, these actions may include submission of content, such as images, text, video, and/or network links. In other embodiments, these actions may include interactions between users of the networking and interaction interface 120. For example, a user may comment on a piece of content provided by another user. In another example, a user may provide feedback on a comment or on content using pre-set motivator means, such as motivator buttons or links which allow a user to express an opinion in a regulated manner. Thus, in various embodiments, a user may click a “Like” button below a comment. In another example a user may utilize motivators to rate a comment or piece of content by clicking a button or link that indicates that the comment or piece of content is “funny,” or “interesting,” or “relevant.” In other embodiments, the opinions for users to choose from may be negative in place of, or in addition to, being positive. In other embodiments, other forms of interaction between users and between users and the networking and interaction interface 120 may be received, such as users requesting files, participating in chat sessions, forming “friend” or “colleague” relationships, and others. In various embodiments, an action may be associated with one user, or with multiple users. Particular implementations of receiving action indications are described below.

In various embodiments, when an indication of an action is received by the networking and interaction interface operation module 200, the networking and interaction interface operation module 200 may forward the indication of the action to the action queue 230, which may store action indications for processing later. The action queue may then forward the action indications to a rule checking module 240. In various embodiments, the action queue may forward the action indications in various orders, such as, for example, first in, first out; first in, last out; and/or based on one or more criteria such as action type or action importance.

After receiving the forwarded action indication, the rule checking module 240 may interact with a historical action storage 250 to store the received action indication for later review. The rule checking module 240 may also send requests to the historical action storage 250 to obtain one or more historical actions, as illustrated. In various embodiments, the rule checking module 240 may then check both the indicated action, as well as the received historical actions, to determine if one or more rules have been satisfied. In various embodiments, if the rule checking module 240 determines that one or more rules have been satisfied, the rule checking module 240 may determine that one or more cultural classifications have been modified for a user or users and/or that one or more cultural signifiers, such as awards, mascots or badges, may be associated with the user or users for which an action indication was received. In some embodiments, the rule checking module may also determine that the user has earned one or more points for marketplace purchases, as described herein. Particular implementations of rule checking processes and marketplaces are described below.

If the rule checking module 240 determines that one or more rules have been satisfied and that cultural classifications are to be modified, cultural signifiers are to be assigned, and/or marketplace points are to be earned, the rule checking module 240 may communicate with the notification generation module 260. The communication may include indications of the classification modification, cultural signifiers, and/or marketplace points. This notification generation module 260 may then forward the cultural classification, assigned cultural signifiers, and/or marketplace points to a push notification module 220, which may then send indications of the cultural classification, assigned cultural signifiers, and/or marketplace points to the networking and interaction interface operation module 200 in order to inform users that they have received a cultural classification, new cultural signifier, such as a badge, and/or marketplace points and indication of the behavior that generated the cultural signifier. In various embodiments, the push notification module 220 may inform users in other methods, such as, for example, through text messaging, email, or other messaging processes.

This notification generation module 260 may also forward the new cultural classification, assigned cultural signifiers, and/or marketplace points to a cultural measurement storage 210. This cultural measurement storage 210 may then provide cultural information to the networking and interaction interface operation module 200. In various embodiments, the cultural measurement storage 210 may provide both new and historical cultural information to users through the networking and interaction interface operation module 200. For example, in various embodiments, users may review classification, cultural signifier, and/or other cultural profile information from the cultural measurement storage through the networking and interaction interface 120. Users may use this information to determine the effects of their interactions through the networking and interaction interface 120 on the organization. In other embodiments, the cultural measurement storage 210 may provide aggregated cultural information to one or more user users 190, such as aggregated user cultural classifications, cultural signifiers, and other information, such as through the cultural dashboard interface 125. Such aggregated information, may facilitate a super user 190 to review organizational culture at higher levels.

As discussed, in various embodiments, the organization culture measurement system 100 may further provide a marketplace (not pictured) whereby a user may purchase tangible and/or intangible goods and/or services that are desirable to persons in the organization. In various embodiments, the marketplace may be provided as part of the networking and interaction interface 120. In various embodiments, the marketplace may operate using a point-based currency. The currency may be earned in various embodiments by users according to actions both on the networking and interaction interface 120 and outside of the interface 120. In some embodiments, currency points may be earned automatically as a result of earning a classification and/or a cultural signifier. In some embodiments, the amount of points earned through these automatic techniques may be modified, such as by a super user who wishes to incentivize particular behavior. For example, in an organization where a super user wishes to incentivize creative thinking, the super user may apply a multiplier to points earned by creative actions. In various embodiments, users may transfer one or more points between themselves or gift points, such as in gratitude for particular actions. In various embodiments, the points may be maintained by the cultural measurement storage 210 for review, trading, and or conversion into goods and/or services. In various embodiments, the goods and/or services that may be purchased through the marketplace may include, but are not limited to: physical products, software products, discounts, online services, and/or organizational recognition or privileges.

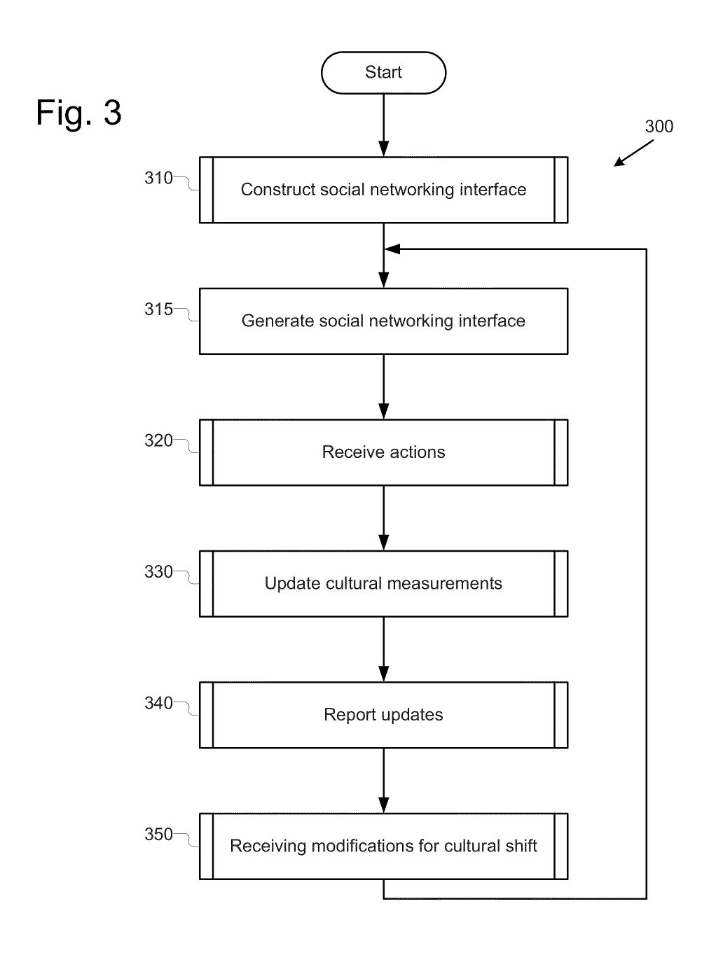

FIG. 3 is a flowchart illustrating an exemplary process 300 for measuring organizational culture for an organization. In various embodiments, one or more of the operations illustrated in FIG. 3 may be combined, split into multiple operations, or omitted altogether. Additionally, while process 300 lists receipt of actions in a particular illustrative order, in various embodiments, actions may be received in any order and in series or in parallel.

The process may begin at operation 310, where the networking and interaction interface operation module 200 may facilitate construction of the networking and interaction interface 120. Particular implementations of operation 310 are described below. At operation 315, the networking and interaction interface operation module 200 may generate the constructed networking and interaction interface 120 for presentation to one or more users 180. As discussed above, in various embodiments the networking and interaction interface operation module 200 may generate the networking and interaction interface 120 through the generation or modification of a web-based interface and/or through interaction with one or more native applications running on client devices operated by users.

At operation 320, the networking and interaction interface 120 may receive one or more actions, such as from user(s) 180 interacting with the networking and interaction interface 120. Particular implementations of operation 320 are described below. At operation 330, cultural measurements may be updated by the organization culture measurement system 100. In various embodiments, the updating of cultural measurements may be performed by the organization culture measurement system 100 with reference to particular users, with reference to the entire organization, and/or with reference to subunits of the organization, such as departments and/or offices. Particular implementations of operation 330 are described below. At operation 340, the organization culture measurement system 100 may then report these updates to users and/or super users, as appropriate. Particular implementations of operation 340 are described below. At operation 350 the organization culture measurement system 100 may receive one or more modifications to the organization culture measurement system 100 in order to effect cultural shift. The process then may repeat, with one or more repetitions of: the modified social networking interface being generated, actions being received, cultural measurements being updated, updates being reported, and additional modifications being received. In various embodiments, through repetition of one or more of these operations allows the organization to dynamically measure, review, and affect its culture as it goes through its operations.

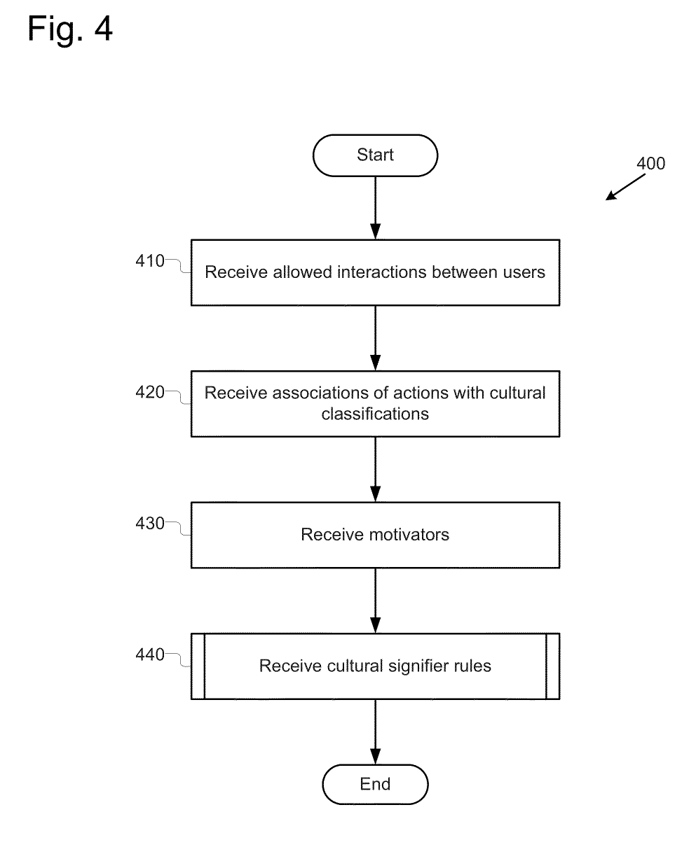

FIG. 4 is a flowchart illustrating an exemplary process for the organization culture measurement system 100 to generate a networking and interaction interface. In various embodiments, one or more of the operations illustrated in FIG. 4 may be combined, split into multiple operations, or omitted altogether. Additionally, while process 400 lists receipt of actions in a particular illustrative order, in various embodiments, actions may be received in any order and in series or in parallel. It may be noted as well that, in various embodiments, operations of process 400 may be performed prior to use of the networking and interaction interface 120 by users, such as part of one or more implementations of operation 310 of FIG. 3. In some embodiments, operations of process 400 may be performed during use of the interface, such as by super users who wish to modify organizational culture by encouraging and/or discouraging particular interactions on the networking and interaction interface 120. In such embodiments, process 400 may be performed by the networking and interaction interface operation module 200 as part of one or more implementations of operation 350 of FIG. 3.

The process may begin at operation 410, where the networking and interaction interface operation module 200 may receive allowed interactions between users. For example, the networking and interaction interface operation module 200 may receive indications of types of content may be shared, opinions and ratings which are supported for users, limitations on feedback, etc. Next, at operation 420, the networking and interaction interface operation module 200 may receive associations of actions which may be performed by users and cultural classifications. Particular examples of these associations are described below. At operation 430, the networking and interaction interface operation module 200 may receive motivators to be used by users to rate or otherwise comment on other users' actions. Particular examples of these motivators are described below. At operation 440, the networking and interaction interface operation module 200 may receive rules for assignment of cultural signifiers, such as badges. Operation of rules and assignment of cultural signifiers are also described below. The process may then end.

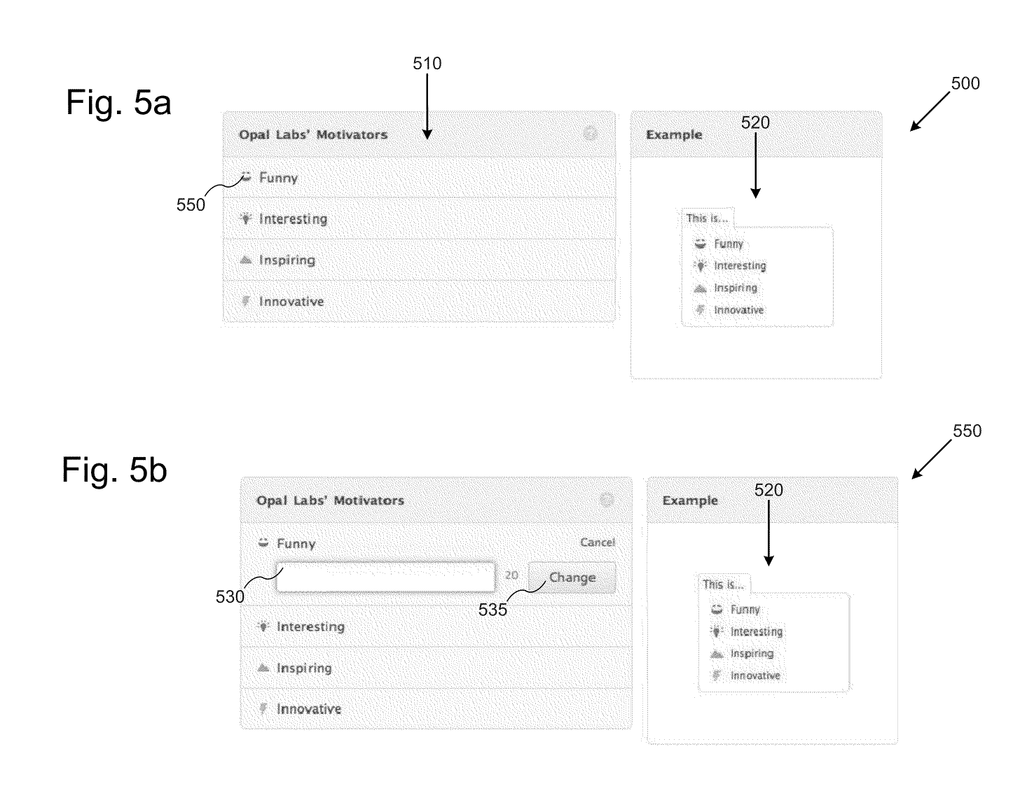

FIGS. 5a and 5b are exemplary interfaces 500 and 550 through which a super user may view and/or modify motivators to reflect unique cultural behaviors. In various embodiments, interfaces 500 and 550 may be provided to a super user as part of the cultural dashboard interface 125. In various embodiments, interfaces 500 and 550 may be provided to a super user to allow the super user to provide and/or modify motivators, as an implementation of operation 430 of FIG. 4. As illustrated in FIG. 5a, the interface 500 may comprise a list 510 of motivators which are currently configured to be used by users 180 interacting with the networking and interaction interface 120. While the particular examples of FIGS. 5a and 5b illustrate four motivators named “Funny,” “Interesting,” “Inspiring,” and “Innovative,” in other embodiments other motivators may be used. For example, in various embodiments, motivators such as “Exciting,” “Smart,” “Insightful,” “Helpful,” “Great build,” “Good contribution,” etc. may be used. In various embodiments, motivators may comprise text and/or may have icons or other images associated with them, such as, for example, icon 550. In some embodiments, the interfaces may provide examples 520 of how the motivators will look to a user of the networking and interaction interface 120.

In various embodiments, an organization using the organization culture measurement system 100 may be able to modify one or more motivators, as illustrated in interface 550 of FIG. 5b. Thus, in various embodiments a super user 190 may enter a replacement modifier into a text box 530, and indicate that an existing motivator should be changed to the newly-entered motivator through activation of a user interface element 535. In some embodiments, a super user 190 may be able to modify icons associated with the motivators as well.

As discussed above, in various embodiments, cultural signifier rules may be received in order to define cultural signifiers, such as at operation 440 of FIG. 4. In various embodiments, cultural signifiers may be received and defined in the organization culture measurement system 100 in the form of one or more of conditions, actions, containers, contexts, and filters. In various embodiments, a cultural signifier may be defined using one or more conditions that may be met if particular combination of action and context are found. For example, in one embodiment, a condition may be met if the rule checking module 240 can find at least one event. In another embodiment, a condition may be met if the rule checking module 240 can find an action that repeats a specified number of times with a given periodicity. For example, the condition may define that the action happen X times per Y, where Y is some period of time like one or more minutes, hours, days, months, or years, or some other arbitrary span of time. In yet another embodiment, a condition may be met if the rule checking module 240 can find an action that repeats a specified number of times with each repetition happening to different users, objects, or elements of in the organization culture measurement system 100. In various embodiments, the context defined in a condition may specify an object, content type, or other information associated with an action being checked.

In some embodiments, conditions may be defined to be in containers. In various embodiments, a condition container may additionally have one or more filters associated with conditions the containers contain and which further modify the behavior of the condition. For example, in various embodiments, containers may include filters which restrict results to historical events that match the action and context that the condition container was built for; the filter may additionally restrict results based on system and/or user id of an event currently being processed. In some embodiments, containers may include filters which restrict results to historical actions which occurred after a given point in time; this check may be implemented by looking backwards a pre-set number of seconds from a timestamp of an action currently being processed. In some embodiments, containers may include filters which restrict results to historical actions which were associated with a same target object as an action currently being processed.

In various embodiments, conditions and condition containers may exist at multiple levels. In some embodiments, the organization culture measurement system may utilize a top-level condition container. This top-level, condition container may comprise one action and one context. Condition containers, in turn may be combined with other condition containers. For example condition containers may be combined via one or more logical And, Or, and Not connectives. In such an embodiments, a condition container may be considered to be True if its underlying condition is met when evaluated with its associated filters applied. In various embodiments, when a set of one or more logically connected condition containers evaluates to True when run against an incoming action, a “goal met” function may be run. In particular embodiments, this “goal met” function may signal the organization culture measurement system 100 to award a cultural signifier, such as a badge, to the user associated with the action that was processed. Embodiments of this checking process are described herein.

In various embodiments, actions and contexts may be defined and checked using particular action and context names. The action name and context may be represented as arbitrary strings that may be compared to other arbitrary strings in the historical action storage 250 and against one or more rules by the rule checking module 240. By providing the ability to arbitrarily match names, in some embodiments, the organization culture measurement system 100 may facilitate a super user in adding his or her own particularized action name and context name strings and to build rules around those strings. In other embodiments, other particular identifying information may be used

In some embodiments, however, actions and/or contexts may be defined using broader definitions, such as search operators. In such an embodiment, a condition container may match multiple actions and/or contexts. For example, in various embodiments condition containers may match any actions in any context. In another example, in some embodiments, a condition container may match, any action in a specified context. In such an embodiment, a condition container may match an “upload” action regardless of whether the “upload” action is associated with a file or a photo. In other examples, other actions may be matched. In yet another example, in some embodiments, a condition container may match some actions meeting some criteria in some contexts. For example, the condition container may match any context that contains a particular string in its name, such as “opportunity,” or “challenge.” In some embodiments, a condition container may exclude some actions. For example, the condition container may match any action except those that are “post” actions.

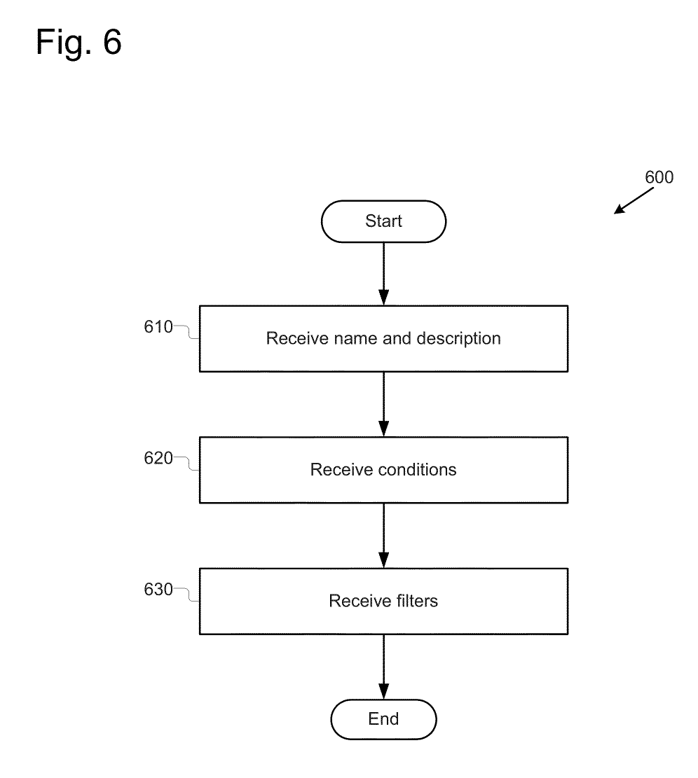

FIG. 6 is a flowchart illustrating an exemplary process for the organization culture measurement system 100 to receive cultural signifier definitions. In various embodiments, one or more of the operations illustrated in FIG. 6 may be combined, split into multiple operations, or omitted altogether. Additionally, while process 600 lists receipt of actions in a particular illustrative order, in various embodiments, actions may be received in any order and in series or in parallel. In various embodiments, the organization culture measurement system 100 may receive cultural signifier definitions through interactions of super user(s) 190 through the cultural dashboard interface 125. At process 610, the organization culture measurement system 100 may receive a name and description for a cultural signifier. At operation 620, the organization culture measurement system 100 may receive one or more conditions for a cultural signifier. At operation 630, the organization culture measurement system 100 may receive one or more filters for the cultural signifier.

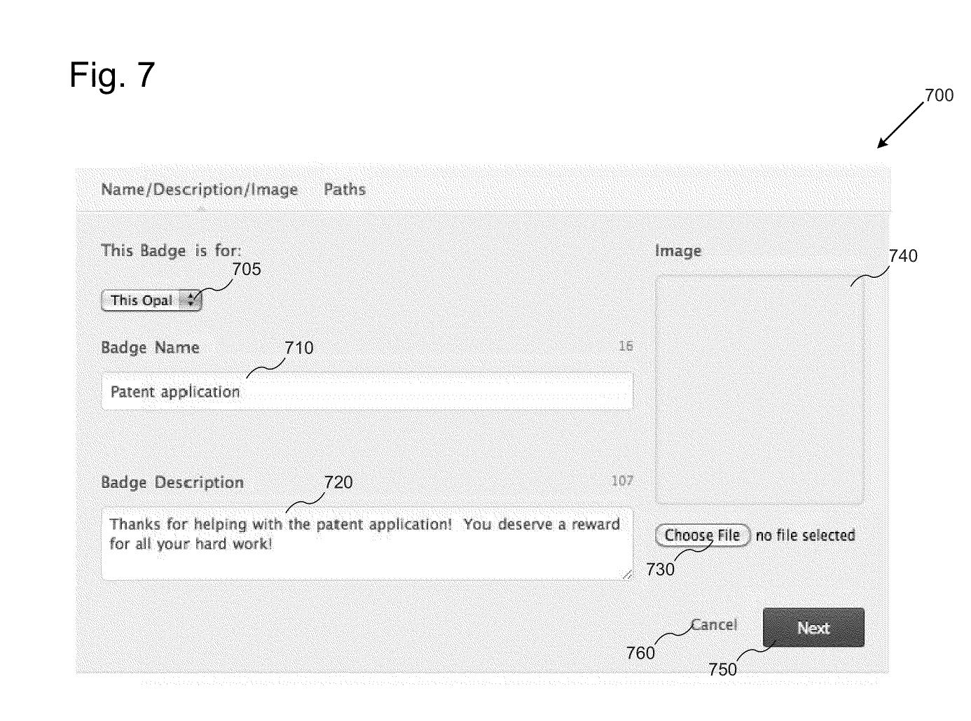

FIG. 7 is an exemplary interface 700 for a super user 190 to generate a cultural signifier; in the example of interface 700, the cultural signifier is a badge that can be viewed by and displayed to users. In various embodiments, interface 700 may be provided as part of cultural dashboard interface 125 by the organization culture measurement system 100 in order for a super user to provide a name and description for a cultural signifier. Thus, as illustrated, interface 700 may provide text input fields 710 and 720 for a super user to enter a name and a description for a particular badge. In various embodiments, interface 700 may provide other inputs. For example, interface 700 may provide a user interface element 730 through which a super user may choose a file for an image to be associated with the generated badge; the image selected may then be displayed to the super user 190 in the image window 740. Additionally, in some embodiments, the interface 700 may provide a user element 705 for a super user 190 to associate the generated badge with different organizations or instantiations of the organization culture measurement system 100. Thus, if the super user generating the badge is associated with more than one organization, he or she may be able to create badges for one or more organizations. Interface 700 may also comprise a user element, such as the Next element 750, for the super user 190 to continue with badge generation, or a cancel element 760.

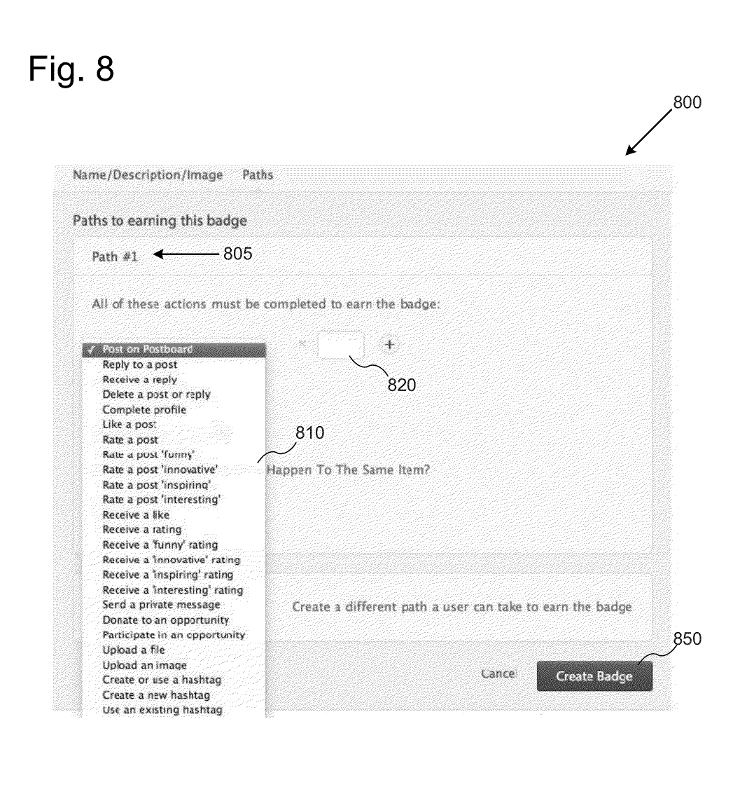

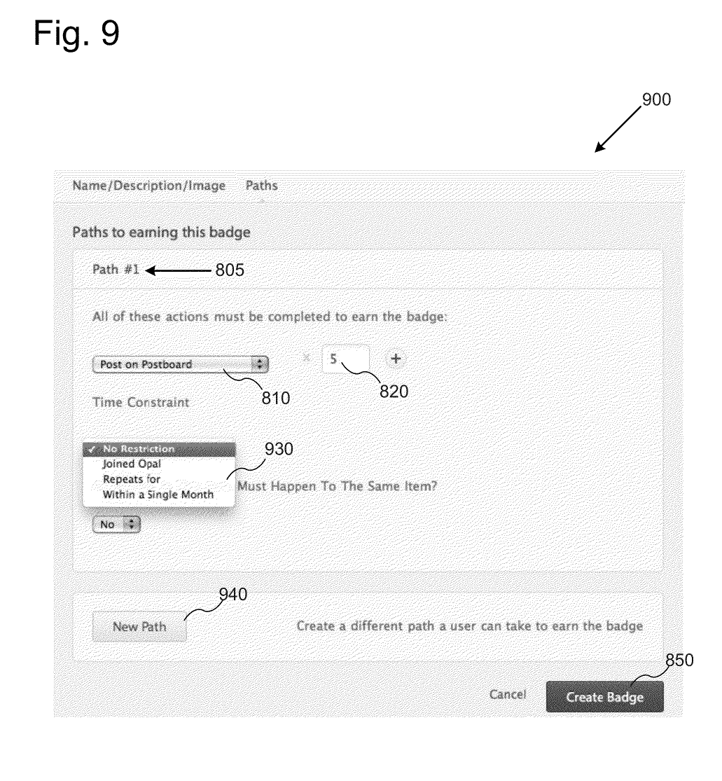

FIGS. 8 and 9 are other exemplary interfaces 800 and 900 for a super user 190 to generate a cultural signifier. As in the example of FIG. 7, in the example of interfaces 800 and 900, the cultural signifier is a badge that can be viewed by and displayed to users. In various embodiments, interfaces 800 and 900 may be provided as part of cultural dashboard interface 125 by the organization culture measurement system 100 in order for a super user to indicate conditions and/or filters for a badge to be earned by a user. Thus, in various embodiments, interface 800 may include a drop-down menu 810 that includes selections of pre-set actions and contexts for a super user to choose from. As illustrated, in interface 900, the “Post on Postboard” condition has been selected. In various embodiments, interface 800 may also include a repetition entry field 820, where a super user may enter a number of times that he or she wishes the selected condition to be performed for the badge to be earned. As illustrated in interface 900, a super user 190 has indicated that, for the particular badge being created to be earned, a user must perform the “Post on Postboard” action 5 times in order to satisfy the condition of this particular badge. As illustrated in interface 900, the super user may also identify a filter for the condition, such as whether the user who performed an action did the conditioned actions all within a single month, or has repeated the action for a particular amount of time; such identification may take place using an element such as drop down menu 930.

As discussed above, in various embodiments, multiple conditions may be created for a particular cultural signifier. In the examples of FIGS. 8 and 9, each condition is identified as a “path.” In various embodiments, if a super user whishes to require multiple conditions, he or she may generate a new path by selecting a new path user interface element 940. The super user may then select additional conditions and/or filters for the badge. And, as illustrated in interfaces 800 and 900, when the super user 190 wishes to finalize the badge he or she has created, he or she may select a “Create Badge” user interface element 850.

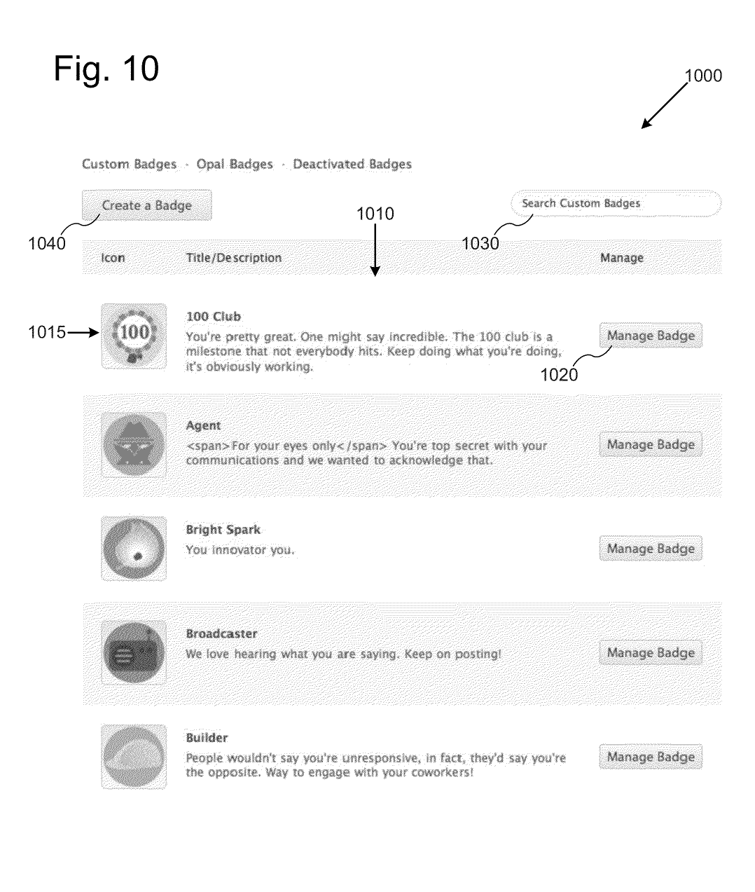

FIG. 10 is an exemplary interface 1000 for a super user 190 to view and manage generated cultural signifiers. In various embodiments, interface 1000 may be provided as part of cultural dashboard interface 125 by the organization culture measurement system 100 in order for a super user to search for and view created cultural signifiers, modify created cultural signifiers. As FIG. 10 illustrates, in various embodiments, interface 1000 may comprise a list of cultural signifiers, which are illustrated in FIG. 10 as a list 1010 of badges. For each badge, the list 1010 may comprise descriptive material 1015, such as an icon, a title, and a description that is displayed to a user receiving the badge. Additionally, the interface 1000 may comprise a “Manage Badge” user interface element 1020, which may be configured to allow a super user 190 to modify the badge definition to reflect changing and/or desired cultural characteristics. In various embodiments, such modification may allow the super user to apply culture shifting techniques to the organization, such as by modifying conditions for achieving badges. The interface 1000 may additionally comprise a search user interface element 1030 for the super user to use if the list of badges 1010 becomes unwieldy, as well as a “Create a Badge” user interface element 1040, which may allow a super user to generate new badges, as described herein.

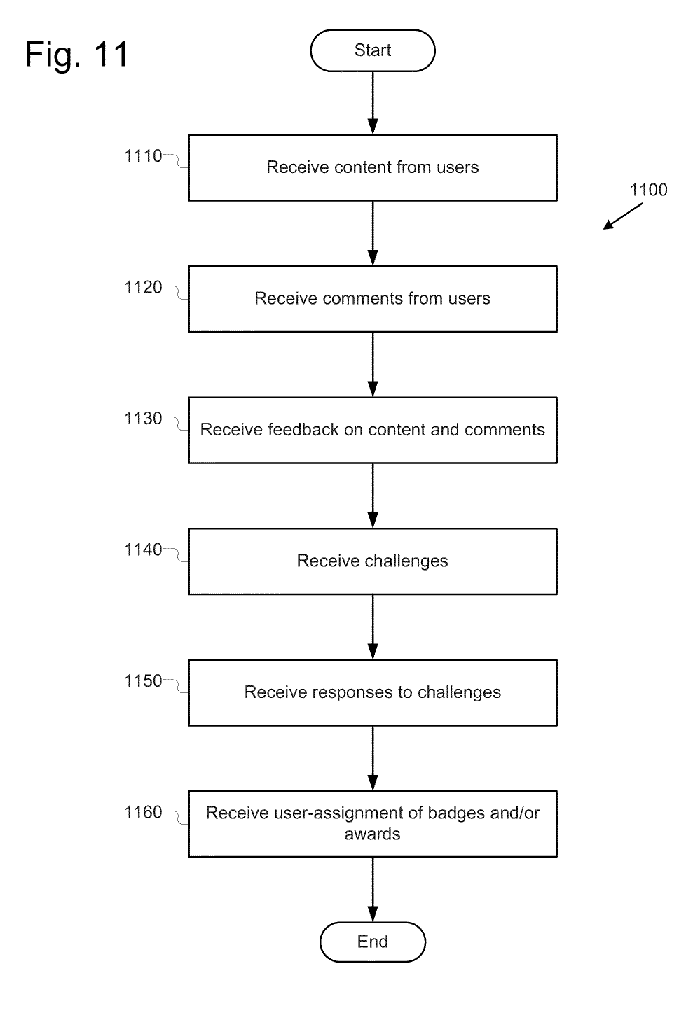

FIG. 11 is a flowchart illustrating an exemplary process 1100 for the organization culture measurement system 100 to receive user actions. In various embodiments, one or more of the operations illustrated in FIG. 11 may be combined, split into multiple operations, or omitted altogether. Additionally, while process 1100 lists receipt of actions in a particular illustrative order, in various embodiments, actions may be received in any order and in series or in parallel as users interact with the networking and interaction interface 120. In various embodiments, process 1100 may be performed as part of one or more implementations of operation 320 of FIG. 3. In various embodiments, the receiving operations described herein may be performed using the networking and interaction interface 120 as an intermediary.

The process may begin at operation 1110, where the networking and interaction interface operation module 200 may receive content from users. In various embodiments, received content may include photos, videos, text-based content, links to websites, polls, and/or other static or interactive elements. At operation 1120, the networking and interaction interface operation module 200 may receive comments from users, such as in response to content viewed on the networking and interaction interface 120.

At operation 1130, the networking and interaction interface operation module 200 may receive one or more pieces of feedback on content and/or comments. In various embodiments, the received feedback may comprise indications of motivators selected by users. For example, as discussed above, a user may express an opinion or rating using pre-set motivator means, such as buttons or links which allow a user to express an opinion in a regulated manner. In other embodiments, the networking and interaction interface operation module 200 may perform searches through user comments to identify keywords or symbols which indicate feedback or other interactions between users. For example, if a user types “Ha ha!” in response to another user's comment, the networking and interaction interface operation module 200 may identify that the first user has provided feedback that the other user's comment is funny. As discussed above, in some embodiments, other forms of interaction between users and between users and the social network may be received, such as users requesting files, participating in chat sessions, forming “friend” or “colleague” relationships, and others.

At operation 1140, the networking and interaction interface operation module 200 may receive one or more challenges, such as from users or super users, for persons in the organization to participate in particular ways. For example, a user may post to the networking and interaction interface 120 that he or she is looking for persons for a particular project that fit particular cultural classifications. In another example, a super user may post a challenge to users to obtain particular cultural signifiers. In various embodiments, the challenges may be time-limited, or limited to a particular number of persons.

At operation 1150, the networking and interaction interface operation module 200 may receive one or more responses to the received challenges. Thus, in one embodiment, a user with a particular cultural classification may volunteer to work on a project for which a challenge was issued. In another embodiment, a user may simply obtain a cultural signifier that a super user has requested. While processes for automatic assignment of cultural signifiers is discussed below, in some embodiments, at operation 1160, the networking and interaction interface operation module 200 may receive indications that particular users are to be assigned cultural signifiers or other awards by users, such as by a super user. Thus, users may be given awards as voted on by their peers, or may be given badges that are only available if a user is recognized by super users. The process may then end.

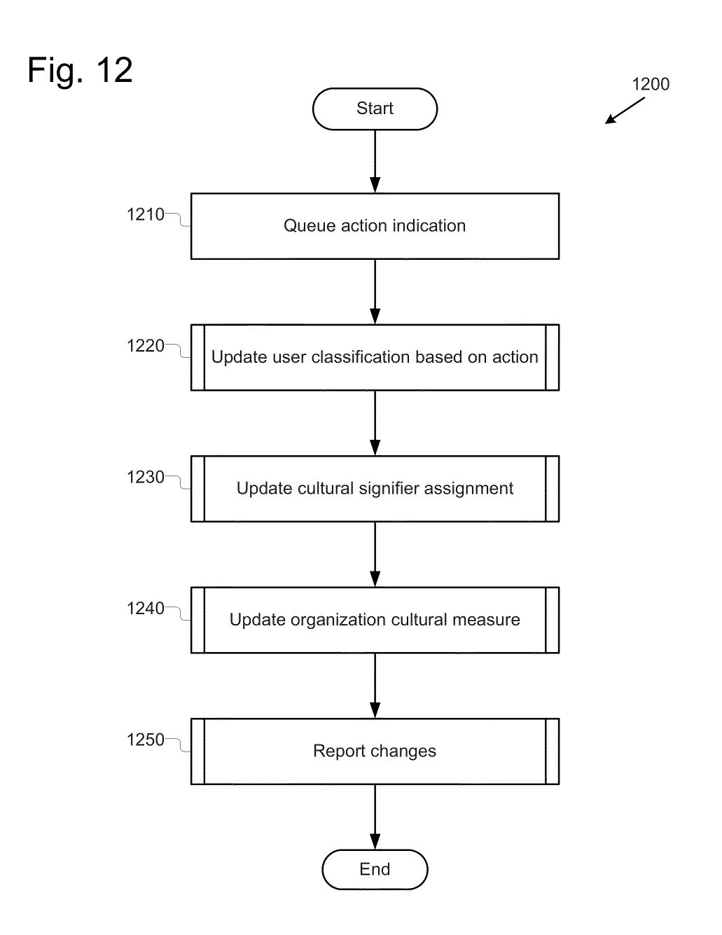

FIG. 12 is a flowchart illustrating an exemplary process 1200 for the organization culture measurement system 100 to update a cultural measure for an organization. In various embodiments, one or more of the operations illustrated in FIG. 12 may be combined, split into multiple operations, or omitted altogether. In various embodiments, process 1200 may be performed as part of one or more implementations of operation 330 of FIG. 3. The process may begin at operation 1210, where the action queue 230 may queue the indication of the action that has been received from the networking and interaction interface operation module 200. As discussed above, the action may be queued for release from the queue in various orders. At operation 1220, the organization culture measurement system 100 may update user classifications based on the received action indication. In various embodiments, operation 1220 may be performed by the rule checking module 240; particular implementations of operation 1220 are described below.

Next, at operation 1230, the organization culture measurement system 100 may update a cultural signifier assignment for a user for which the action indication was received. In various embodiments, operation 1230 may be performed by the rule checking module 240; particular implementations of operation 1220 are described below. At operation 1240, the organization culture measurement system 100 may update organization cultural measurements based on the received action. In various embodiments, operation 1240 may be performed by the rule checking module 240; particular implementations of operation 1240 are described below. At operation 1250, the organization culture measurement system 100 may report the updates that were performed at operations 1230 and 1240. In various embodiments, operation 1250 may be performed by the notification generation module 260, the push notification module 220, the cultural measurement storage 210, and the networking and interaction interface operation module 200; particular implementations of operation 1250 are described below

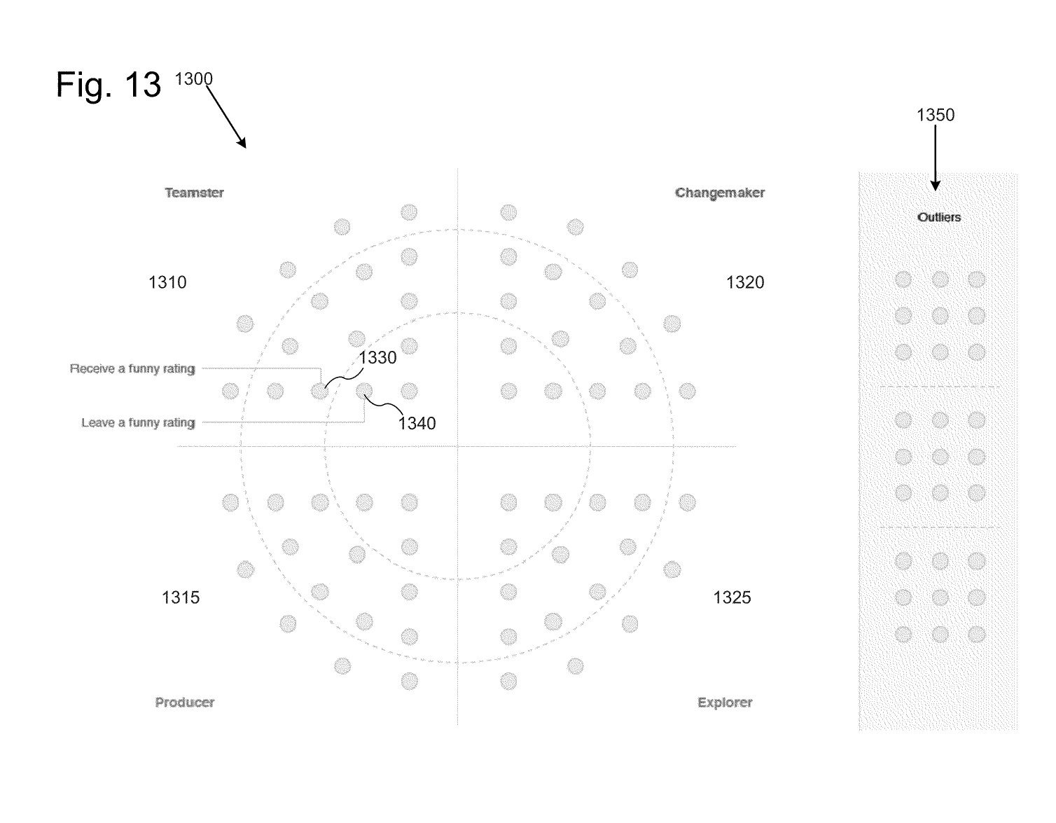

FIG. 13 illustrates an example interface 1300 through which a user may observe actions which have been captured by the organization culture measurement system 100 and which may be used to update his or her cultural classifications and/or signifiers. In various embodiments, interface 1300 may be provided to a user as part of the networking and interaction interface 120.

Interface 1300 indicates that a user may have many potential actions which he or she may perform, or which may be performed with relation to him or her, represented by the small circles. As illustrated in interface 1300, each action may be classified into a classification, which are represented in interface 1300 as different quadrants. Thus, in the example of interface 1300, actions may be classified as “Teamster” type (quadrant 1310), “Producer” type (quadrant 1315), “Changemaker” type (quadrant 1320), and/or “Explorer” type (quadrant 1325). Further, some actions may not fit neatly into a particular classification, and may be illustrated in the interface as outliers 1350. As interface 1300 also illustrates, different actions may be directly performed by the user, such as action 1340, which is indicated if the user leaves a rating for a comment indicating that the comment is “funny”. In various embodiments, however, actions associated with a user may be performed by other users, such as action 1330, which is indicated for a user if a comment left by the user receives a funny rating from another user. In various embodiments, the particular classifications may be modified according the needs of the organization and/or the desires of one or more super users.

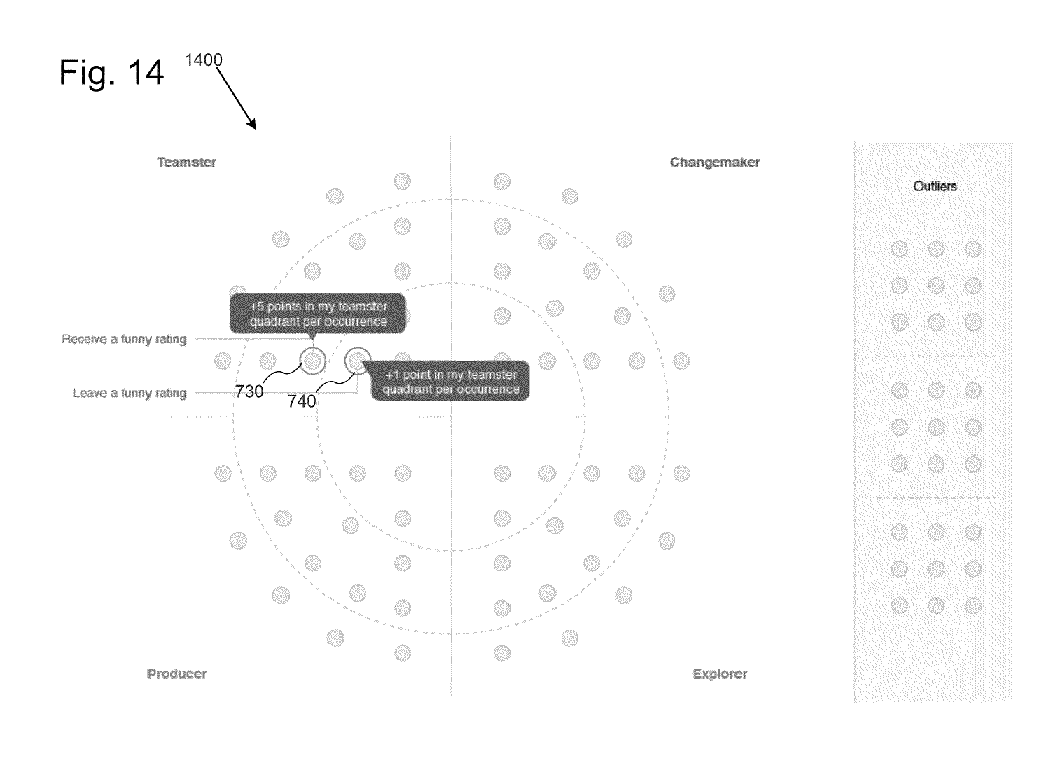

FIG. 14 illustrates another example interface 1400 through which a user may observe actions which have been captured by the organization culture measurement system 100 and which may be used to update his or her cultural classifications and/or signifiers. In various embodiments, interface 1400 may be provided to a user as part of the networking and interaction interface 120. As interface 1400 illustrates, different actions may contribute differently to a user's cultural classification. For example, action 1340, which is achieved by a user simply for leaving a rating of “funny” on another user's comment, may contribute a single point to the user's “Teamster” classification. In contrast, action 1330, which is achieved by a user being rated as funny, may contribute five points to the same classification. As interface 1400 shows, through the assignment of different point values to different actions, an organization may incentivize performance of particular by users over others.

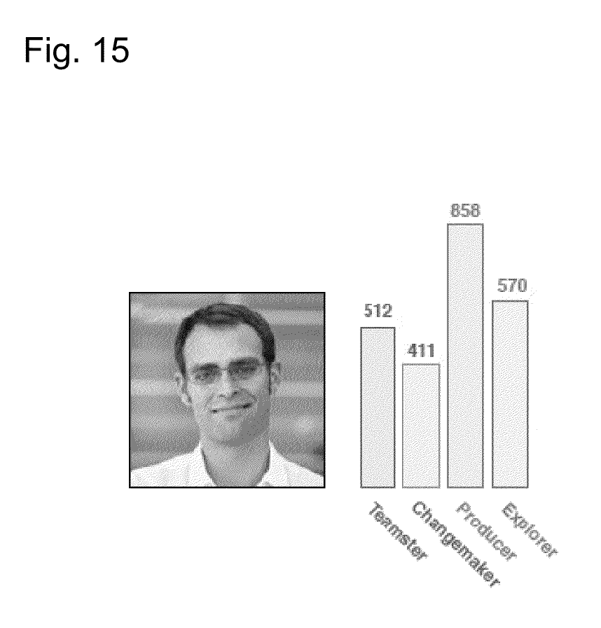

FIG. 15 illustrates an exemplary interface provided by the organization culture measurement system 100 for a user to observe a profile associated with the user. In various embodiments, the profile may illustrate, among other information, degrees of cultural classifications pertaining to the user. In various embodiments, interface 1500 may be provided to a user as part of the networking and interaction interface 120, such as in a report to the user. As FIG. 15 illustrates, in various embodiments, a user may receive various point values which relate to particular classifications. As discussed earlier, these point values may be received based on the user's actions in the networking and interaction interface 120, the actions of others in the networking and interaction interface 120, or combinations of the two types of actions. In the example of FIG. 15, the user has acquired different points in different classifications. For example, the user has acquired 858 “Producer” points, but 411 “Changemaker” points. By reviewing the particular points that the user has acquired, the organization culture measurement system 100 allows the user to see how his or her interactions within the organization contribute to the organization, and allows other users, such as super users, to observe his or her contributions as well. In various embodiments, the user profile may contain additional material, such as cultural signifiers (for example, badges) that the user has been associated with.

In various embodiments, the user profile may be visible to various parties. For example, in some embodiments, the user profile may be visible only to the user, while in others, the user profile may be visible to super users and/or other users in the organization. In yet other embodiments, the profile may be visible to people outside of the organization. For example, in some embodiments, the user profile may be maintained by a third party so that the user can continue his or her association with the user profile even if the user is no longer associated with the organization. In such embodiments, the user profile may act as a cultural resume, and may be made available to other organizations in order to demonstrate the user's particular strengths and/or weaknesses to those organizations.

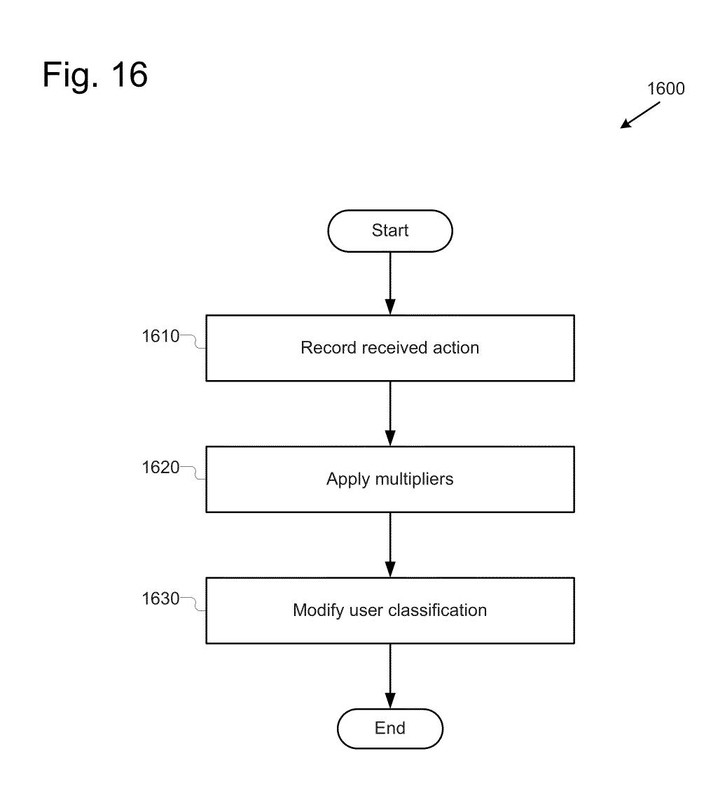

FIG. 16 is a flowchart illustrating an exemplary process 1600 for the organization culture measurement system 200 to update user cultural classifications. In various embodiments, one or more of the operations illustrated in FIG. 16 may be combined, split into multiple operations, or omitted altogether. In various embodiments, process 1600 may be performed by the rule checking module 240 as part of one or more implementations of operation 1220 of FIG. 12. The process may begin at operation 1610, where the received action is recorded, such as in the historical action storage 250. As discussed above, in various embodiments, a recorded action may provide one or more points to a classification. However, before any points are applied, at operation 1620, multipliers may be applied to the action. Thus, in the example given above in FIG. 1400, action 1330, which is achieved by a user being rated as funny, may be multiplied by five before points are added to the “Teamster” classification. Then, at operation 1630, one or more relevant user classifications may be modified by adding points, as modified by relevant multipliers, to the classifications. The process may then end.

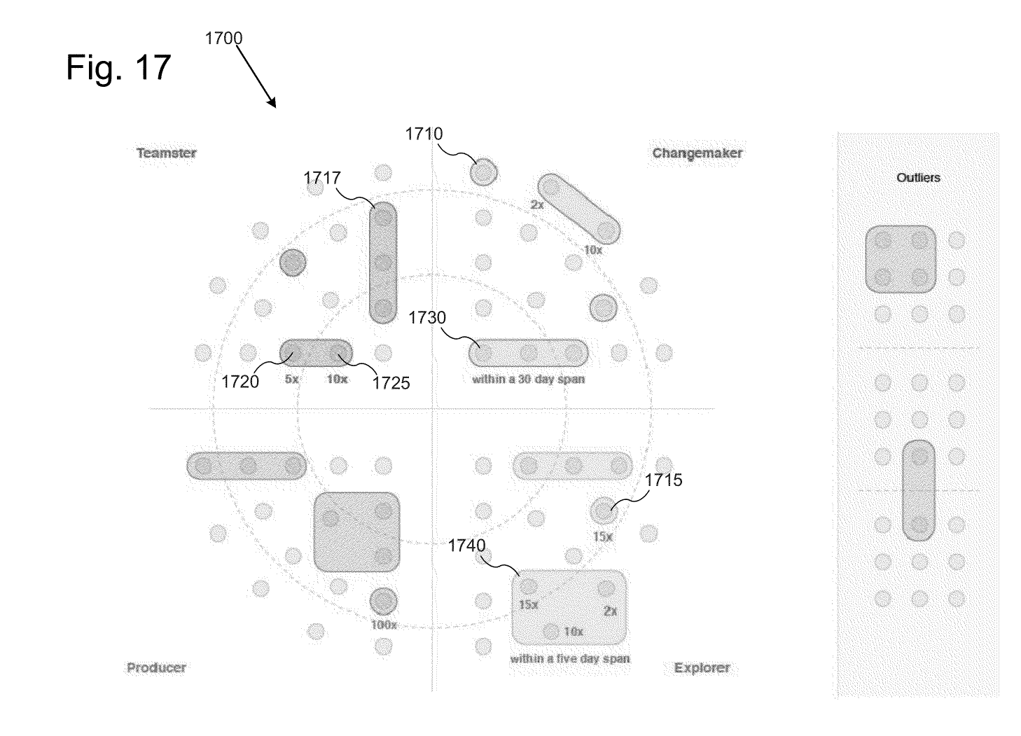

FIG. 17 illustrates an exemplary interface 1700 provided by the organization culture measurement system 100 for a super user to observe a user's progress in obtaining cultural signifiers. In various embodiments, interface 1700 may be provided to a user as part of the cultural dashboard interface 125. As interface 1700 illustrates, different actions may contribute differently to a user receiving cultural signifiers. For example, in some embodiments, a cultural signifier may be earned by a user simply because a particular action is received with respect to that user; for example, the user may earn a cultural signifier simply by being associated with action 1710. In another example, as discussed above, an action may need to be performed multiple times in order for a user to achieve the cultural signifier; for example, action 1715 may only earn a cultural signifier for the user if it is performed 15 times.

In other embodiments, as discussed above, earning cultural signifiers may require that combinations of actions be performed. For example, a cultural signifier referred to by reference 1717 may be assigned if three separate actions are performed. Further, some cultural signifiers may require multiple actions to be performed multiple times; for example in the example, a cultural signifier is earned if action 1720 is performed five times and action 1725 is performed ten times. In yet other embodiments, the organization culture measurement system 100 may assign a cultural signifier if actions are performed within a particular time span., For example, the cultural signifier associated with reference 1730 requires three actions be performed within a 30-day span, and the cultural signifier associated with reference 1740 requires three actions be performed multiple times within a five-day span.

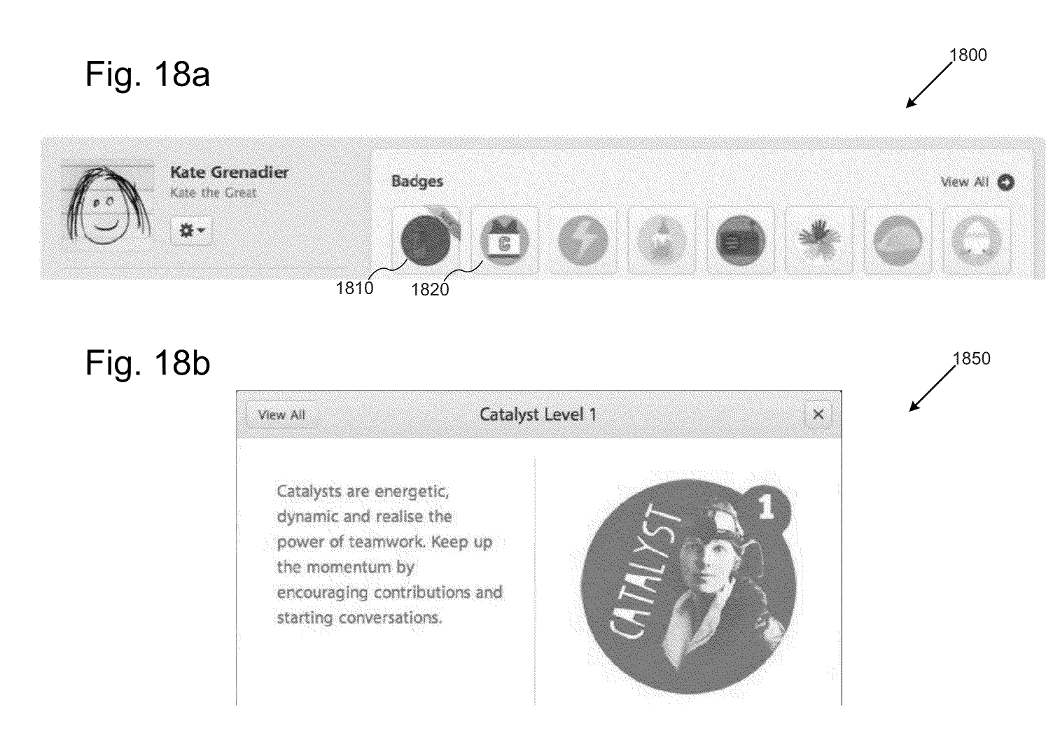

FIGS. 18a and 18b are exemplary interfaces 1800 and 1850 for a user 180 to view earned cultural signifiers. In various embodiments, interfaces 1800 and 850 may be provided as part of the networking and interaction interface 120 by the organization culture measurement system 100 and may be displayed as part of a user profile. Interface 1800 illustrates various cultural signifiers earned by a user, such as cultural signifiers 1810. In various embodiments, if the user selects a cultural signifier, he or she may view interface 1850, which illustrates information about the cultural signifier. As illustrated, and as discussed above, this information may include title information, description information, and/or an icon.

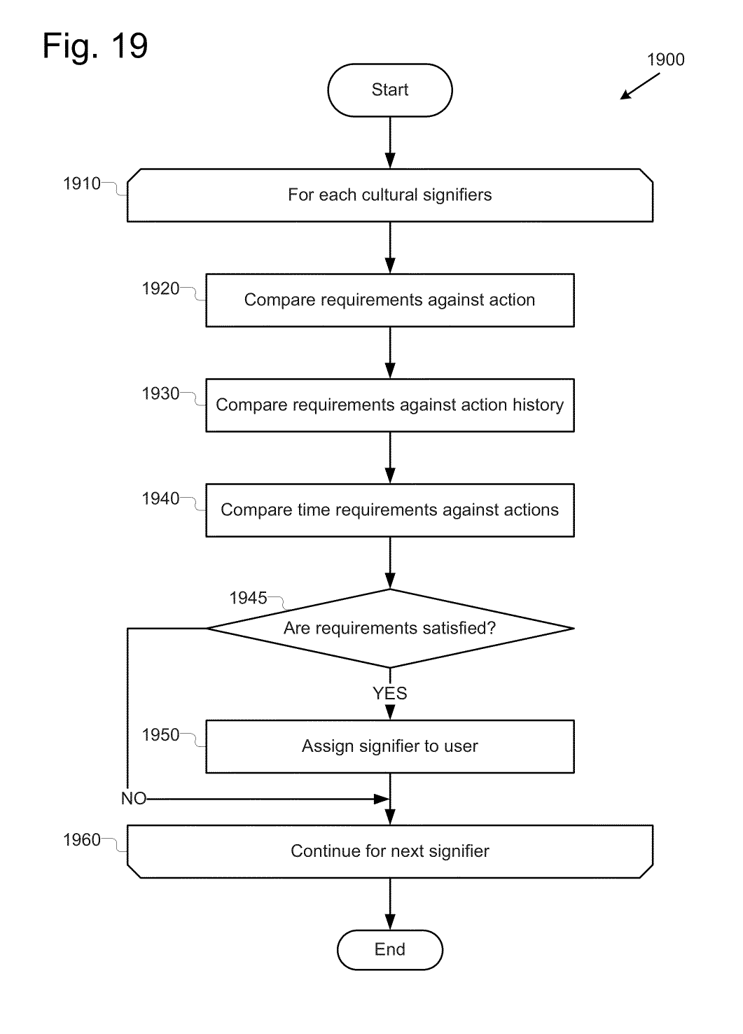

FIG. 19 is a flowchart illustrating an exemplary process 1900 for the organization culture measurement system 200 to update cultural signifier assignments for a user. In various embodiments, one or more of the operations illustrated in FIG. 19 may be combined, split into multiple operations, or omitted altogether. In various embodiments, process 1900 may be performed by the rule checking module 240 as part of one or more implementations of operation 1230 of FIG. 12. The process may begin at loop operation 1910, where a loop is started for multiple cultural signifiers. At operation 1920, the rule checking module 240 may compare requirements for the cultural signifier against the action just received for the user. As described above, in various embodiments, this comparison may comprise comparing the action against a condition in a condition container. In some embodiments, if no cultural signifiers are applicable for the action just received, then the process may end for that cultural signifier.

Next, at operation 1930, the rule checking module 240 may compare requirements for the cultural signifier against action history for the user. In various embodiments, if the cultural signifier being compared requires, such as through a filter, that the action needs to be performed multiple times, the comparison may include determining if the action history includes past performances of the action. In various embodiments, if the cultural signifier being compared requires multiple different actions, the comparison performed at operation 1930 may include comparing multiple past actions. At operation 1940, the rule checking module 240 may compare any time requirements for the cultural signifier against the reviewed actions to determine if the actions were performed within the time requirements.

Next, at decision operation 1945, the rule checking module 240 may determine if the requirements which were compared at operations 1920, 1930, and 1940 were satisfied. If the requirements were not satisfied, then the rule checking module 240 may continue to review cultural signifier requirements for the next cultural signifier at loop operation 1960. If the requirements were satisfied, then at operation 1950, the rule checking module 240 may assign the cultural signifier to the user. Then the rule checking module 240 may continue to the next cultural signifier at loop operation 1960. After each cultural signifier has been compared, the process may then end.

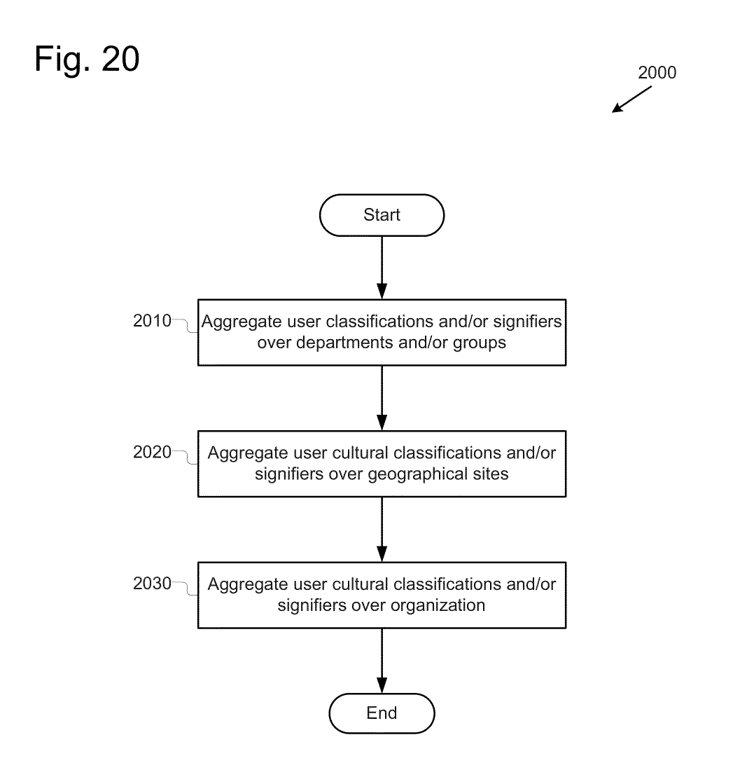

FIG. 20 is a flowchart illustrating an exemplary process 2000 for the organization culture measurement system 100 to update organization culture measurement. In various embodiments, one or more of the operations illustrated in FIG. 20 may be combined, split into multiple operations, or omitted altogether. In various embodiments, process 2000 may be performed as part of one or more implementations of operation 1240 of FIG. 12. In various embodiments, the organization culture measurement system 100 may aggregate user classifications and/or cultural signifiers into multi-person cultural measurements. In some embodiments, these measurements may be viewed by super users, such as through the networking and interaction interface 120.

The process may begin at operation 2010, wherein the organization culture measurement system 100 may aggregate user classifications and/or badges over users in particular departments and/or groups. Thus, for example, the organization culture measurement system 100 may determine that persons in a particular department are predominantly of the “Changemaker” type, or that few “Teamsters” exist in a particular department. In this way, the organization culture measurement system 100 may be used to identify particular imbalances that a department may have compared to other departments in the organization, or may help identify departments with complementary skill sets. In various embodiments, the groups over which aggregations are performed at operation 1210 may be defined by, but are not limited to: the organizational structure of the organization; common interests, common demographics, projects, products, and/or other factors. Next, at operation 2020, the organization culture measurement system 100 may aggregate user classifications and/or badges over users in at particular physical sites or offices. The ability to measure culture over a site, rather than simply at an organizational level, may be important, as users at a particular site will have more in-person interaction than users across different physical locations. Finally, at operation 2030, the organization culture measurement system 100 may aggregate user classifications and/or badges over the entire organization. The process may then end.

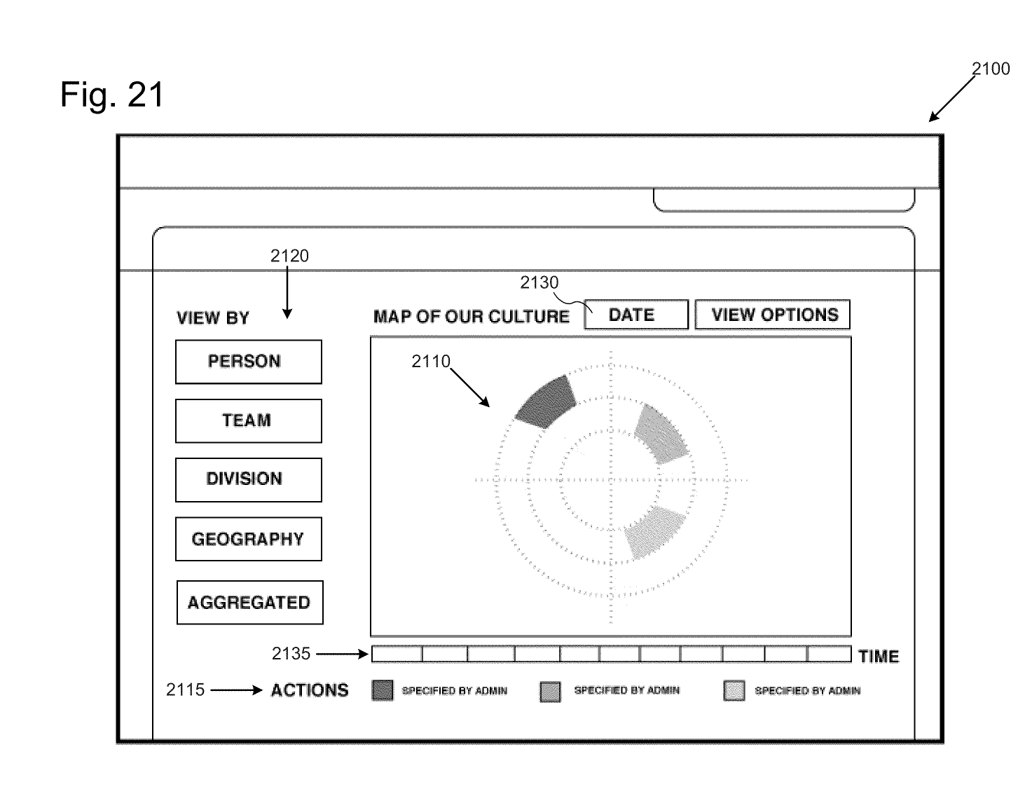

FIG. 21 is an exemplary interface 2100 for a super user 190 to view aggregated cultural measurements. In various embodiments, interface 2100 may be provided as part of cultural dashboard interface 125 by the organization culture measurement system 100 in order for a super user to see how cultural measurements are aggregated across the organization. In various embodiments, interface 2100 may provide a mapping 2110 of aggregated cultural measurement. In various embodiments, this aggregated data may be illustrated using levels for different quadrant classifications, as discussed above. In various embodiments, the interface 2100 may utilize different colors to provide indications of how strongly different cultural classifications have been found in the organization. Thus, the mapping 2110 may show a strong cultural measurement for the organization in the classification represented by the upper left quadrant, while showing less strong cultural indications in the other quadrants. These indicators may be explained in a cultural key, such as key 2115. In an alternative embodiment, the circles illustrated in the quadrants themselves may be drawn bigger or smaller to indicate stronger or weaker measurements.

In various embodiments, the interface 2100 may allow for a super user 190 to view the cultural data aggregation over different groups, such as those illustrated in the list of views 2120. Thus, by clicking the super user 190 may cause the organization culture measurement system 100 to show data for the entire organization, by particular geography, team, division, or on an individual person basis. In various embodiments, the interface 2100 may also facilitate the super user 190 in viewing changes in the organizational culture over time. Thus, the super user 190 may activate a date user interface element 2130 to see cultural measurements on a particular date. In other embodiments, the interface 2100 may provide a time slider 2135 or other time-based user interface element for the user to witness changes in cultural measurements over time. In various embodiments, interface 2100 may be updated in real time as the super user views the interface.

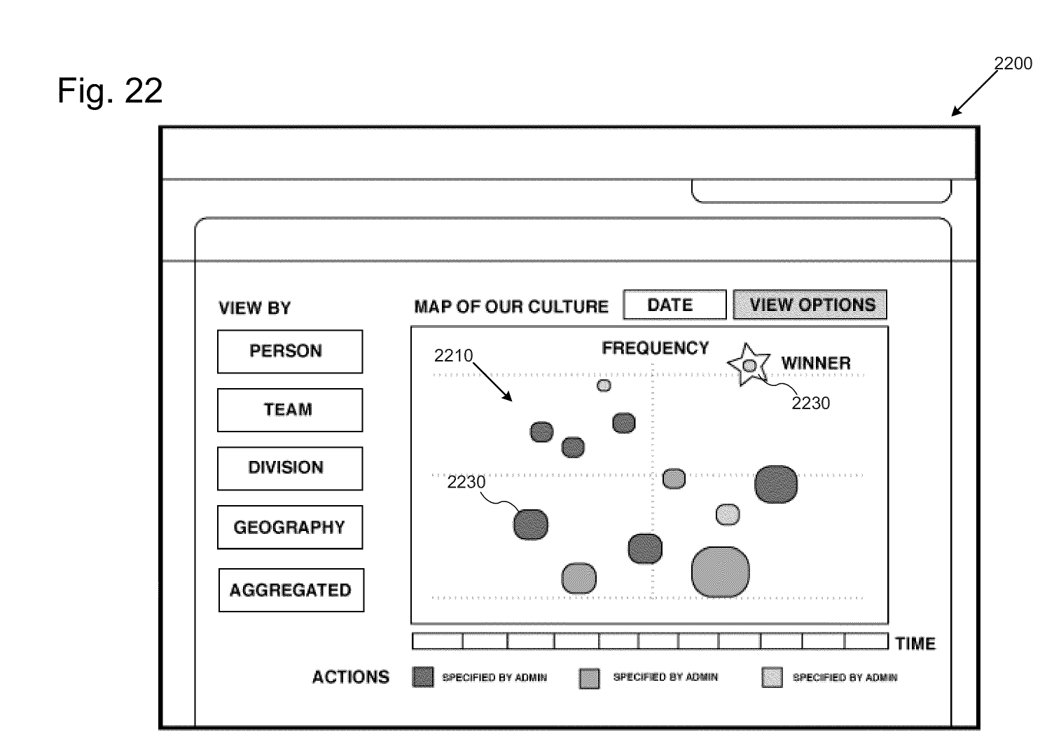

FIG. 22 is another exemplary interface 2200 for a super user 190 to view aggregated cultural measurements. In various embodiments, interface 2200 may be provided as part of cultural dashboard interface 125 by the organization culture measurement system 100 in order for a super user to see how cultural measurements are aggregated across the organization in a different format. As illustrated in interface 2200, the organization culture measurement system 100 may illustrate a mapping 2210 of regions, such as region 2230, of a cultural mapping for which frequent points and/or actions have been measured. In various embodiments, this mapping may show a “cultural heat map” for the edification of the super user 190. In various embodiments, in a similar manner to the mapping provided in interface 2100, different colors or shades may be used to denote frequency of particular hot regions. Additionally, the interface 2200 may, in various embodiments, denote particular regions as particularly desirable, such as the “Winner” region 2230. In various embodiments, interface 2200 may provide the super user 190 with different controls to view cultural measurement aggregations over groups, geographical sites, or time, as discussed above. In various embodiments, interface 2200 may be updated in real time as the super user views the interface.

While the examples of FIGS. 21 and 22 illustrate organizational culture measurement from a mapping perspective, in other embodiments, other visualization techniques may be used, such as a line graph visualization. In various embodiments, the line graph visualization may display amount of activity in various cultural classifications over time, allowing an organization to see how they are evolving and individual teams to compare progress and even compete for achievement of desired cultural traits. In various embodiments, the line graph visualization may be updated in real time.

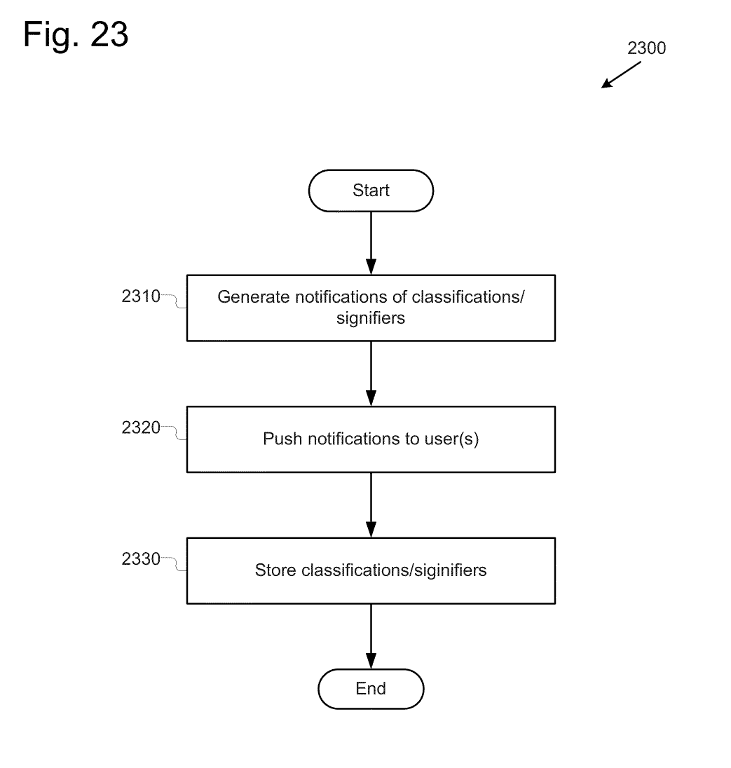

FIG. 23 is a flowchart illustrating an exemplary process 2300 for the organization culture measurement system 100 to inform users of updates. In various embodiments, one or more of the operations illustrated in FIG. 23 may be combined, split into multiple operations, or omitted altogether. In various embodiments, process 2300 may be performed as part of one or more implementations of operations 340 of FIG. 3 and/or 1250 of FIG. 12. The process may begin at operation 2310, where the notification generation module 260 may generate one or more notifications relating to classification and/or cultural signifier updates received from the rule checking module 240. Next, at operation 2320, the push notification module 220 may push notifications to one or more users. For example, the push notification module 220 may inform users using the networking and interaction interface 120, or by other methods, such as, for example, through text messaging, email, or other messaging processes. Next, at operation 2330, the organization culture measurement system 100 may store the classifications and/or cultural signifiers received in the cultural measurement storage 210. In various embodiments, the stored classifications and/or badges may be reviewed later though the networking and interaction interface 120 by users and/or super users. The process may then end.

FIG. 15 illustrates a generalized example of a suitable computing environment 1500 in which several of the described embodiments may be implemented. The computing environment 1500 is not intended to suggest any limitation as to scope of use or functionality, as the techniques and tools may be implemented in diverse general-purpose or special-purpose computing environments such as personal computers, consumer electronic devices, and the like.

With reference to FIG. 15, the computing environment 1500 includes at least one CPU 1510 and associated memory 1520. In FIG. 15, this most basic configuration 1530 is included within a dashed line. The processing unit 1510 may execute computer-executable instructions and may be a real or a virtual processor. In a multi-processing system, multiple processing units execute computer-executable instructions to increase processing power. The memory 1520 may be volatile memory (e.g., registers, cache, RAM), non-volatile memory (e.g., ROM, EEPROM, flash memory, etc.), or some combination of the two. The memory 1520 may store software 1580 implementing the techniques described herein.

A computing environment may have additional features. For example, the computing environment 1500 may include storage 1540, one or more input devices 1550, one or more output devices 1560, and one or more communication connections 1570. An interconnection mechanism (not shown) such as a bus, controller, or network may interconnect the components of the computing environment 1500. Typically, operating system software (not shown) may provide an operating environment for other software executing in the computing environment 1500, and may coordinate activities of the components of the computing environment 1500.

The storage 1540 may be removable or non-removable, and includes magnetic disks, magnetic tapes or cassettes, CD-ROMs, DVDs, flash drives, disk arrays, or any other medium which can be used to store information and which can be accessed within the computing environment 1500. The storage 1540 may store instructions for the software.

The input device(s) 1550 may be a touch input device such as a keyboard, mouse, pen, or trackball, a voice input device, a scanning device, or another device that provides input to the computing environment 1500. For audio or video encoding, the input device(s) 1550 may be a sound card, video card, TV tuner card, or similar device that accepts audio or video input in analog or digital form, or a CD- or DVD-based drive that reads audio or video samples into the computing environment 1500. The output device(s) 1760 may be a display (e.g., monitor, display screen, or the like), printer, speaker, DVD-writer, or another device that provides output from the computing environment 1500.

The communication connection(s) 1570 may enable communication over a communication medium to another computing entity. The communication medium may convey information such as computer-executable instructions, audio or video input or output, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The techniques and tools may be described in the general context of non-transitory computer-readable media. Computer-readable media are any available media that can be accessed within a computing environment. By way of example, and not limitation, with the computing environment 1500, computer-readable media may include memory 1520, computer-readable storage media 1540 (e.g., CDs, DVDs, diskettes, flash drives, removable hard drives, hard drive arrays), and combinations of any of the above.

The techniques and tools may be described in the general context of computer-executable instructions, such as those included in program modules, being executed in a computing environment on a target real or virtual processor. Generally, program modules may include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing environment.

For the sake of presentation, the detailed description uses terms like “determine,” “compare,” and “record” to describe computer operations in a computing environment. These terms are high-level abstractions for operations performed by a computer, and should not be confused with acts performed by a human being. The actual computer operations corresponding to these terms vary depending on implementation.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A computer-implemented method for measuring culture for an organization, the method comprising:
receiving, by one or more computing devices, an indication of an action performed by one or more persons associated with the organization; and
adjusting, by the one or more computing devices, a cultural measurement for the organization based on the classified interaction.

2. The method of claim 1, wherein the receiving and adjusting are performed by the computing devices in real time.

3. The method of claim 1, further comprising providing, by the one or more computing devices, a networking and interaction interface for one or more persons in the organization; and
wherein the receiving an indication of an action comprises receiving an indication of an interaction between persons on the social interaction interface.

4. The method of claim 3, wherein:
providing the networking and interaction interface includes providing one or more interfaces for persons associated with the organization to provide content for viewing by other persons; and
receiving an indication of an interaction includes receiving an indication that content was provided.

5. The method of claim 4, wherein providing the networking and interaction interface includes providing one or more interfaces for persons associated with the organization to offer feedback on provided content; and
receiving an indication of an interaction includes receiving an indication that feedback was offered.

6. The method of claim 5, wherein the interfaces for persons associated with the organization to offer feedback on provided content include buttons and/or links for persons to indicate motivating ratings.

7. The method of claim 6, wherein the ratings include liking content, ratings that content is funny, ratings that content is interesting, and ratings that content is relevant to a discussion, and/or ratings related to other behaviors valuable to the organization

8. The method of claim 1, wherein the cultural measurement for the organization is based at least in part on associations between persons in the organization and one or more cultural classifications.

9. The method of claim 8, wherein adjusting a cultural measurement for the organization includes adjusting classification of one or more persons associated with the action based at least in part on one or more cultural classifications to which the action is classified as belonging.

10. The method of claim 9, wherein adjusting classification of one or more persons comprises associating one or more cultural signifiers with the one or more persons based on the interaction.

11. The method of claim 10, wherein associating one or more cultural signifiers includes for a person:
checking a rule associated with a cultural signifier to determine if the action satisfies a rule for achieving the cultural signifier; and
if the rule for achieving the cultural signifier is satisfied, associating the cultural signifier with the person.

12. The method of claim 11, further comprising:
generating, by the one or more computing devices, a new rule for a new cultural signifier;
upon receiving an indication of an interaction associated with a second person, the one or more computing devices checking if the new rule is satisfied; and
if the new rule is satisfied, associating the new cultural signifier with the second person.

13. The method of claim 10, wherein the one or more cultural signifiers comprise visual signifiers.

14. The method of claim 9, wherein adjusting classification of one or more persons comprises associating one or more cultural classifications with the one or more persons based on the action.

15. The method of claim 1, further comprising displaying, by the one or more computing devices, a graphical indication of actions associated with a person.

16. The method of claim 1, further comprising displaying, by the one or more computing devices, a graphical indication of classifications of persons in the organization.

17. A system for measuring organizational culture based on interactions between persons associated with an organization, the system comprising:
one or more computer processors;
one or more networking and interaction interface modules configured, in response to execution by the one or more computer processors, to:
generate a networking and interaction interface; and
receive networking interactions associated with a person in the organization via the networked networking and interaction interface; and
one or more cultural measurement modules configured, in response to execution by the one or more computer processors, to:
compare interactions received via the networking and interaction interface to pre-defined rules to determine if one or more of the cultural rules are satisfied; and
if one or more rules are satisfied by the received interactions, associating one or more cultural signifiers with the person.

18. The system of claim 17, wherein the cultural measurement modules are further configured to determine if one or more of the rules are satisfied by comparing one or more historical interactions with the pre-defined rules.

19. The system of claim 17, wherein the networking and interaction interface modules are further configured to generate the networking and interaction interface to allow persons to provide comments to each other and to provide feedback to the comments; and wherein the networking interactions include the comments and the feedback to the comments.

20. The system of claim 17, wherein the networking and interaction interface modules are further configured to generate the networking and interaction interface to allow generation of a task-related challenge and one or more second persons to accept the task-related challenge; and
wherein the networking interactions include the generation of the challenge and the acceptance of the challenge.

21. The system of claim 17, wherein the cultural measurement modules are further configured to associate one or more cultural classifications with the person based at least in part on the received interactions.

22. One or more computer-readable media containing instructions which, responsive to execution by one or more computing devices, cause the devices to perform operations for measuring cultural interactions in an organization, the operations including:
providing a social network for one or more persons in the organization
receiving an indication of an interaction on the social network between persons associated with the organization;
classifying the interaction as belonging to one or more cultural categories out of a set of pre-determined cultural categories; and
adjusting a cultural measurement for the organization based on the classified interaction.

23. The computer-readable media of claim 22, wherein adjusting a cultural measurement for the organization includes:
checking a rule associated with a cultural signifier to determine if the interaction satisfies a rule for achieving the cultural signifier; and
if the rule for achieving the cultural signifier is satisfied, associating the cultural signifier with a person associated with the interaction.

24. The computer-readable media of claim 23, wherein adjusting a cultural measurement for the organization further includes:
determining one or more cultural metrics for the organization based on assigned cultural signifiers for persons associated with the organization.

25. The computer-readable media of claim 22, wherein adjusting a cultural measurement for the organization includes:
associating one or more cultural categories with the one or more persons based on the interaction; and
determining one or more cultural metrics for the organization based on assigned cultural categories for persons associated with the organization
